(19) United States
(12) Patent Application Publication
(10) Pub. No.: US 2020/0231794 A1
(43) Pub. Date: Jul. 23, 2020

(54) IMPROVING INTER-ROAD ADHESION AND COALESCENCE IN PLASTIC PARTS FABRICATED IN 3D PRINTING

(71) Applicant: IMERYS TALC AMERICA, INC., Roswell, GA (US)

(72) Inventors: Neil TREAT, San Jose, CA (US); Daniele BONACCHI, Bellinozona (CH)

(21) Appl. No.: 16/483,205

(22) PCT Filed: Dec. 13, 2017
(86) PCT No.: PCT/US2017/066086

§ 371 Date: Aug. 2, 2019

Related U.S. Application Data
(60) Provisional application No. 62/453,616, filed on Feb. 2, 2017.

(51) Int. Cl. C08L 23/14; C08K 3/34; C08K 3/04; B33Y 70/00; B29C 64/106

(52) U.S. Cl. CPC C08L 23/14; C08K 3/34; C08K 3/04; B29K 2509/02; B29C 64/106; C08L 2205/02; B33Y 70/00

(57) ABSTRACT

This disclosure describes a composition for additive manufacturing, which contains a thermoplastic polymer and a mineral additive capable of reducing a specific heat of the composition relative to a specific heat of the thermoplastic polymer. A proportion of the mineral additive in the composition may be set such that the specific heat of the composition is equal to or less than 95% of the specific heat of the thermoplastic polymer, and the composition may be in the form of a filament, rod, pellet or granule. Compositions disclosed herein may be adapted to function as compositions suitable for performing additive manufacturing by material extrusion. Also disclosed herein are additive manufacturing processes and methods for producing the compositions for fused filament fabrication.

### CLAIM FOR PRIORITY

This PCT International Application claims the benefit of priority of U.S. Provisional Patent Application No. 62/453,616, filed Feb. 2, 2017, the subject matter of which is incorporated herein by reference in its entirety.

### TECHNICAL FIELD

This application relates to materials technology in general and more specifically to the preparation and use of compositions for additive manufacturing. More particularly, this application discloses compositions for additive manufacturing, methods for producing the compositions, additive manufacturing processes using the compositions, and objects formed from the compositions.

### BACKGROUND OF THE INVENTION

In recent years, additive manufacturing (a process which builds parts by layer-by-layer deposition of a given material) has advanced such that many believe that it will replace specific traditional manufacturing techniques (e.g. investment casting). One of the main benefits associated with additive manufacturing is that the layer-by-layer building method allows for access to the inside of the part during its construction, which facilitates facile incorporation of complex internal structures that can achieve significant improvement in mechanical properties relative to the part weight. Additionally, additive manufacturing allows one to rapidly move from 3D computer-aided design (CAD) models to a finished part, thus enabling more efficient prototyping.

Material extrusion (MEX) technology is one such additive manufacturing technique. It is a process where, upon the application of pressure, a material contained in a reservoir is extruded through a nozzle. If the pressure remains constant, then the resulting extruded material (commonly referred to as a “road”) flows at a constant rate and remains a constant cross-sectional diameter. The diameter of the extruded “road” will remain constant if the travel of the nozzle across a depositing surface is also kept at a constant speed that corresponds to the flow rate.

The most commonly used material extrusion approach is to use temperature as a way of controlling the state of matter. In some MEX techniques a solid thermoplastic material is liquefied inside a reservoir so that it flows through a nozzle and bonds with the adjacent material before solidifying. For fabrication of high quality parts, the material that is extruded must be semi-solid when deposited and then fully solidify while having minimal deformation. Additionally, the extruded filament must also bond to the pre-deposited material so as to form a solid structure. It is this combination of limiting material deformation and maximizing inter-filament bonding during sequential deposition that is a challenge for developing new materials for MEX 3D printing.

Polyolefins including polyethylenes (PE) and polypropylenes (PP) are the largest volume polymers in the plastics industry today. Much of this is because of their excellent cost/performance value due to their low density, ease of recyclability, and wide range of processability. For example, polyolefins are typically received in pellet form and can be extruded, blow molded, injection molded, or rotomolded to fabricate a large variety of parts. Additionally, with recent advances in catalyst design, polyolefins have highly tunable molecular architectures and mechanical properties (e.g. ranging from elastomeric to brittle). With this wide range of mechanical properties and processability, it is highly desirable to develop a polyolefin system for use in 3D printing.

One of the challenges of creating MEX 3D printed parts with consistent mechanical properties is producing a solid part from individually deposited polymer “roads”. During the deposition of the molten polymer “roads”, the individual strands must coalesce to form a solid part. The problem of low cohesion between separate layers is especially pronounced in additive manufacturing processes involving the use of polyolefins. Especially for MEX 3D printing applications, the problem of inferior coalescence and adhesion when using polyolefin-containing materials has hindered the commercially-acceptable use of fused deposition modeling (FDM).

### SUMMARY OF THE INVENTION

The present inventors have recognized that a need exists to discover materials and methods enabling improved coalescence and adhesion between the layers of objects formed by additive manufacturing. For example, a need exists to discover polyolefin-based compositions that can be used to produce objects by MEX 3D printing, in which the objects exhibit improved property characteristics due to improved layer-to-layer coalescence and adhesion between the bonded layers. A need also exists to discover methods of preparing and using such polyolefin-based compositions.

The following disclosure describes the preparation and use of compositions for additive manufacturing.

Embodiments of the present disclosure, described herein such that one of ordinary skill in this art can make and use them, include the following:

(1) Some embodiments relate to a composition for additive manufacturing, the composition containing a thermoplastic polymer, and a mineral additive capable of reducing a specific heat of the composition relative to a specific heat of the thermoplastic polymer, wherein: (a) a proportion of the mineral additive in the composition is set such that the specific heat of the composition is equal to or less than 95% of the specific heat of the thermoplastic polymer; (b) the composition is in the form of a filament, rod, pellet or granule; and (c) the composition is adapted to function as a composition suitable for performing additive manufacturing by material extrusion;

(2) Some embodiments relate to an additive manufacturing process, including the steps of: melting the composition of claim 1 to form a molten mixture; delivering the molten mixture onto a working surface to obtain a molten deposit on the working surface; and allowing the molten deposit to solidify to obtain a composite material in the form of a section plane of an object;

(3) Some embodiments relate to a method for producing a composition for fused filament fabrication, the method including the steps of: (i) selecting a thermo-plastic polymer capable of undergoing material extrusion to form a semiliquid; (ii) measuring a specific heat of the thermoplastic polymer; (iii) combining the thermo-plastic polymer with a mineral additive to obtain a composite material; (iv) measuring a specific heat of the composite material; and (v) adjusting a proportion of the mineral additive in the composite material to obtain a composition having a specific heat that is equal to or less than 95% of the specific heat of the thermoplastic polymer;

(4) Some embodiments relate to an additive manufacturing process, including the steps of: melting a solid mixture containing a polyolefin and a mineral additive, to form a molten mixture; delivering the molten mixture onto a working surface at a fill angle relative to a plane of the working surface, to obtain a molten deposit on the working surface; allowing the molten deposit to solidify to obtain a composite material in the form of a section plane of an object; and repeating the melting and delivering steps for successive section planes to fabricate an object, wherein a proportion of the mineral additive in the solid mixture is adjusted such that equation (1) below is satisfied:)

TS(90°)≥0.75×TS(0°) (1),

in which: TS(90°) represents a tensile stress at yield point of an object B formed by delivering the molten mixture onto the working surface at a fill angle of 90°; and TS(0°) represents a tensile stress at yield point of an object A formed by delivering the molten mixture onto the working surface at a fill angle of 0°; and

(5) Some embodiments relate to an additive manufacturing process, including the steps of: separately metering a thermoplastic polymer and a mineral additive into a material extrusion nozzle, and melting a resulting mixture to obtain a molten mixture; delivering the molten mixture onto a surface to obtain a molten deposit that solidifies into a section plane of an object; and repeating the metering, melting and delivering steps for successive section planes to fabricate the object, wherein a mixing ratio of the mineral additive to the thermoplastic polymer is controlled such that at least one of the following conditions is satisfied: (i) a warpage of the object is less than a warpage of an object fabricated by repeatedly performing the melting and delivering steps with the thermoplastic polymer in the absence of the mineral additive; (ii) a tensile stress at yield point of the object is less than a tensile stress at yield point of an object fabricated by repeatedly performing the melting and delivering steps with the thermoplastic polymer in the absence of the mineral additive; (iii) a tensile stress at filament failure point of the object is less than a tensile stress at filament failure point of an object fabricated by repeatedly performing the melting and delivering steps with the thermoplastic polymer in the absence of the mineral additive; (iv) a modulus of elasticity of the object is less than a modulus of elasticity of an object fabricated by repeatedly performing the melting and delivering steps with the thermoplastic polymer in the absence of the mineral additive; and (v) a void space of the object is less than a void space of an object fabricated by repeatedly performing the melting and delivering steps with the thermoplastic polymer in the absence of the mineral additive.

Additional objects, advantages and other features of the present disclosure will be set forth in part in the description that follows and in part will become apparent to those having ordinary skill in the art upon examination of the following or may be learned from the practice of the present disclosure. The present disclosure encompasses other and different embodiments from those specifically described below, and the details herein are capable of modifications in various respects without departing from the present invention. In this regard, the description herein is to be understood as illustrative in nature, and not as restrictive.

### BRIEF DESCRIPTION OF THE DRAWINGS

Embodiments of this disclosure are explained in the following description in view of figures that show:

FIGS. 1(a)-(e) depict cross-sectional scanning electron microscope (SEM) images of 3D printed polyolefin composites;

FIGS. 2(a) & (b) depict (a) a scanning electron microscope (SEM) image of a 3D printed polyolefin composite, and (b) an elliptical representation of fused units of the 3D printed polyolefin composite for use in calculating the radium of curvature and void space of the 3D printed polyolefin composite;

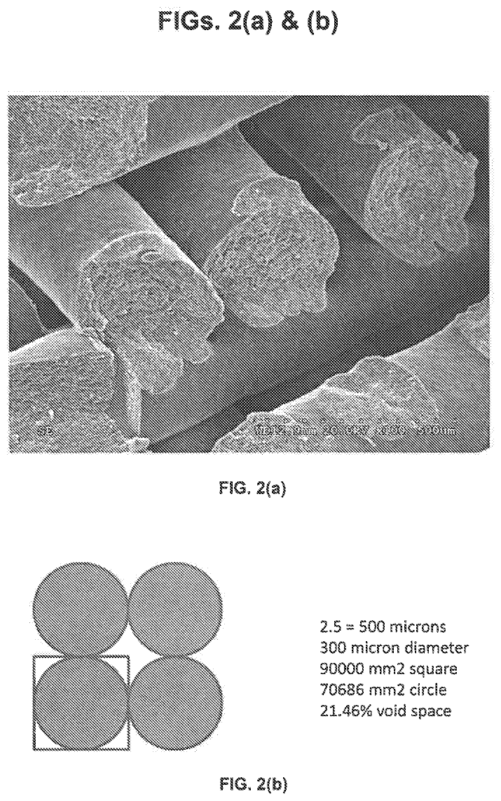

FIGS. 3(a) & (b) depict (a) a scanning electron microscope (SEM) image of a 3D printed polyolefin composite, and (b) an elliptical representation of fused units of the 3D printed polyolefin composite for use in calculating the radium of curvature and void space of the 3D printed polyolefin composite;

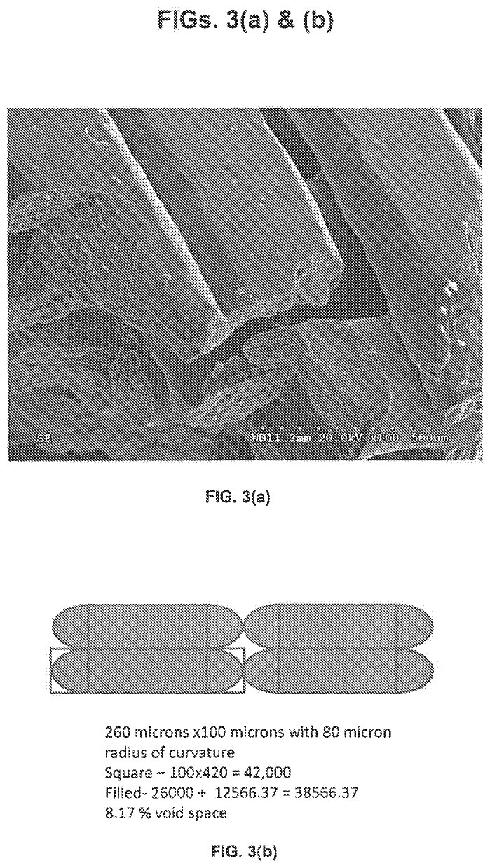

FIGS. 4(a) & (b) depict (a) a scanning electron microscope (SEM) image of a 3D printed polyolefin composite, and (b) an elliptical representation of fused units of the 3D printed polyolefin composite for use in calculating the radium of curvature and void space of the 3D printed polyolefin composite;

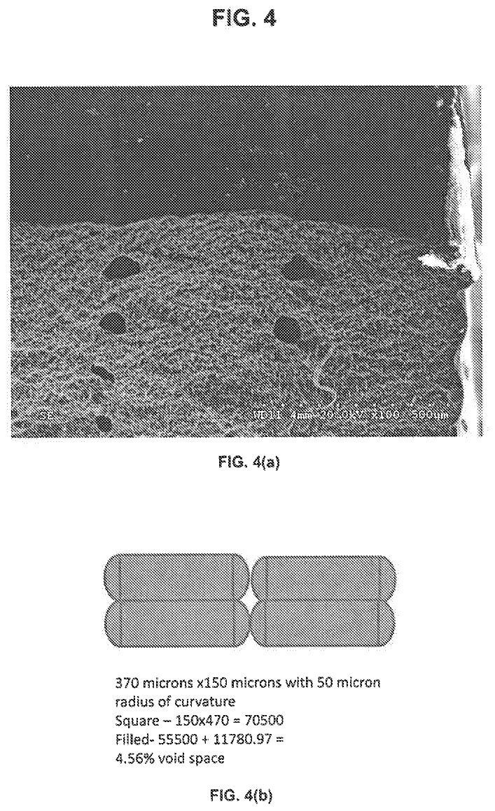

FIG. 5 are plots of experimental warpages for six different objects formed by a fused deposition modeling (FDM) 3D printing method;

FIGS. 6(a)-(d) are graphs of experimental radii of curvature for four different objects formed by a fused deposition modeling (FDM) 3D printing method, in each case the experimental radius of curvature for the object being compared to the experimental radii of curvature for objects formed from a commercial acrylonitrile butadiene styrene (ABS) polymer and a commercial polypropylene (PP) polymer by the 3D printing method;

FIG. 7 depicts an anisotropy test specimen having certain dimensions;

FIGS. 8(a) & (b) are schematic representations showing the cross-sectional constructions of test specimens prepared using fill angles of 0° and 90°, respectively;

FIG. 9 depicts charts showing how the modulii of elasticity of test strips formed using Sample 5 at fill angles of 0° and 90° vary as the temperature is increased from 240° C. to 280° C.;

FIG. 10 depicts charts showing how the tensile stress at filament failure point of test strips formed using Sample 5 at fill angles of 0° and 90° vary as the temperature is increased from 240° C. to 280° C.:

FIG. 11 depicts a high-contrast SEM image used to measure the void space of Sample 12 shown in Table 11;

FIG. 12 depicts a high-contrast SEM image used to measure the void space of Sample 13 shown in Table 11;

FIG. 13 depicts a high-contrast SEM image used to measure the void space of Sample 14 shown in Table 11;

FIG. 14 depicts a high-contrast SEM image used to measure the void space of Sample 15 shown in Table 11; and

FIG. 15 depicts a high-contrast SEM image used to measure the void space of Sample 16 shown in Table 11.

### DETAILED DESCRIPTION

Embodiments of this disclosure include various compositions for additive manufacturing, as well as methods of producing compositions for additive manufacturing, and additive manufacturing processes using the compositions. Compositions of the present disclosure generally contain a polymer and an additive that improves the properties of objects formed by performing additive manufacturing with the compositions.

As explained below in greater detail, without being bound by any particular theory, it is believed that in some embodiments two factors may be responsible for the improved properties of objects formed by performing additive manufacturing with compositions disclosed herein. First, it is believed that polymers having a reduced amount of crystallinity (for example, a low crystallization temperature) may be ideal for performing additive manufacturing relying on material extrusion (MEX). Second, it is believed that formulating the low-crystallinity polymers with additives that reduce the specific heat, viscosity and/or density of the resulting composite material formulations, relative to the specific heat, viscosity and/or density of the starting polymers, can improve the coalescence and adhesion of layers deposited during additive manufacturing, In other embodiments, it is believed that other characteristics of the additive may be responsible for the improved properties of objects formed by performing additive manufacturing processes with compositions of the present disclosure.

### Compositions for Additive Manufacturing

Some embodiments relate to a composition for additive manufacturing, which contains a polymer and an additive that provides the improved physical properties described above. In some embodiments the additive is capable of reducing a specific heat of the composition relative to a specific heat of the polymer. Such compositions may be formulated such that a proportion of the additive in the composition is set such that the specific heat of the composition is equal to or less than 95% of the specific heat of the polymer. Such compositions may also be formulated such that the composition is in the form of a filament, rod, pellet or granule. In some embodiments the composition is adapted to function as a composition suitable for performing additive manufacturing by material extrusion.

In some embodiments the composition may be formulated such that a proportion of the additive in the composition is set such that the specific heat of the composition is equal to or less than 90%, or equal to or less than 85%, or equal to or less than 80%, or equal to or less than 75%, or equal to or less than 70%, or equal to or less than 65%, or equal to or less than 60%, of the specific heat of the polymer.

The “polymer” or “base polymer” may include a thermoplastic polymer, a thermoset polymer, an elastomeric polymer, or any combination thereof. Polymers in the present disclosure may include polyolefins, polyamides, polycarbonates, polyimides, polyurethanes, polyethylenemines, polyoxymethylenes, polyesters, polyacrylates, polylactic acids, polysiloxanes and copolymers and blends thereof such as acrylonitrile-butadiene-styrene (ABS) copolymers, just to name a few. In other embodiments the polymer may include at least one selected from a polystyrene, a polyethylene, a polyamide, a polyurethane, a polyethyl vinyl acetate), a polyethylene terephthalate, and copolymers and blends thereof, to name a few.

In some embodiments the polymer is a thermoplastic polymer in the form of a polyolefin. For example, the composition may contain a thermoplastic polymer containing a random or block co-polyolefin, such that as a random or block co-polypropylene.

Compositions of the present disclosure may also include at least one additional polymer that is different from the base polymer described above. For example, in some embodiments the composition may also include a natural or synthetic polymer that is different from the base polymer. For instance, some compositions of the present disclosure include the base polymer, the additive, and at least one additional polymer selected from a polyamide, a polycarbonate, a polyimide, a polyurethane, a polyalkylenemine, a polyoxyalkylene, a polyester, a polyacrylate, a polylactic acid, a polysiloxane, a polyolefin and copolymers and blends thereof. In other embodiments the composition may include the base polymer, the additive, and an elastomer that is different from the base polymer.

In some embodiments the base polymer is a thermoplastic polymer having a density of equal to or less than 0.9 g/cm³. In other embodiments the density of the thermoplastic polymer may be equal to or less than 0.85 g/cm³, or equal to or less than 0.80 g/cm³, or equal to or less than 0.75 g/cm³, or equal to less or than 0.70 g/cm³. In some embodiments the base polymer is in the form of a crystalline, semi-crystalline or amorphous polymer, such as for example, a crystalline, semi-crystalline or amorphous thermoplastic polymer. For example, some compositions of the present disclosure contain, as the base polymer, a thermoplastic polymer having a crystallization temperature of equal to or less than 70° C. at a cooling rate of 20° C. per minute. In other embodiments, compositions of the present disclosure may contain, as the base polymer, a thermoplastic polymer having a crystallization temperature of equal to or less than 65° C., or equal to or less than 60° C., or equal to or less than 55° C., or equal to or less than 50° C., at a cooling rate of 20° C. per minute.

The “additive” may be an inorganic additive or an organic additive. For example, in some embodiments the additive is in the form of a mineral additive that may include an inorganic mineral, an organic compound, an organic polymer, or mixtures thereof. Additives contained in compositions of the present disclosure may include at least one mineral additive selected from the group consisting of an inorganic mineral, an allotrope of carbon and an organic polymer.

The composition may contain a mineral additive including at least one selected from a silicate, an aluminosilicate, a diatomaceous earth, a perlite, a pumicite, a natural glass, a cellulose, an activated charcoal, a feldspar, a zeolite, a mica, a talc, a clay, a kaolin, a smectite, a wollastonite, a bentonite, and combinations thereof.

For example, compositions of the present disclosure may contain a mineral additive including at least one inorganic mineral selected from the group consisting of phenakite (Be₂SiO₄), willemite (Zn₂SiO₄), forsterite (Mg₂SiO₄), fayalite (Fe₂SiO₄), tephroite (Mn₂SiO₄), pyrope (Mg₃Al₂(SiO₄)₃), almandine (Fe₃Al₂(SiO₄)₃), spessartine (Mn₃Al₂(SiO₄)₃), grossular (Ca₃Al₂(SiO₄)₃), andradite (Ca₃Fe₂(SiO₄)₃), uvarovite (Ca₃Cr₂(SiO₄)₃), hydrogrossular (Ca₃Al₂Si₂O₈(SiO₄)₃₋ₘ(OH)₄ₘ), zircon (ZrSiO₄), thorite ((Th,U)SiO₄), perlite (Al₂SiO₅), andalusite (Al₂SiO₅), kyanite (Al₂SiO₅), sillimanite (Al₂SiO₅), dumortierite (Al_{6.5-7}BO₃(SiO₄)₃(O,OH)₃), topaz (Al₂SiO₄(F,OH)₂), staurolite (Fe₂Al₉(SiO₄)₄(O,OH)₂), humite ((Mg,Fe)₇(SiO₄)₃(F,OH)₂), norbergite (Mg₃(SiO₄)(F,OH)₂), chondrodite (Mg₅(SiO₄)₂(F,OH)₂), humite (Mg₇(SiO₄)₃ (F,OH)₂), clinohumite (Mg₉(SiO₄)₄(F,OH)₂), datolite (CaBSiO₄(OH)), titanite (CaTiSiO₅), chloritoid ((Fe,Mg,Mn)₂Al₄Si₂O₁₀(OH)₄), mullite (aka Porcelainite)(Al₆Si₂O₁₃), hemimorphite (calamine) (Zn₄(Si₂O₇)(OH)₂⋅H₂O), lawsonite (CaAl₂(Si₂O₇)(OH)₂⋅H₂O), ilvaite (_{CaFe}^{II}₂Fe^{III}O(Si₂O₇)(OH)), epidote (Ca₂(Al,Fe)₃O(SiO₄)(Si₂O₇)(OH)), zoisite (Ca₂Al₃O (SiO₄)(Si₂O₇)(OH)), clinozoisite (Ca₂Al₃O(SiO₄)(Si₂O₇)(OH)), tanzanite (Ca₂Al₃O(SiO₄) (Si₂O₇)(OH)), allanite (Ca(Ce,La,Y,Ca)Al₂(Fe^{II},Fe^{III})O(SiO₄)(Si₂O₇) (OH)), dollaseite (Ce)(CaCeMg₂Al Si₃O₁₁ F(OH)), vesuvianite (idocrase) (Ca₁₀(Mg,Fe)₂Al₄(SiO₄)₅ (Si₂O₇)₂(OH)₄), benitoite (BaTi(Si₃O₆), axinite ((Ca,Fe,Mn)₃Al₂(BO₃)(Si₄O₁₂)(OH), beryl/emerald (Be₃Al₂(Si₆O₁₆), sugilite (KNa₂(Fe,Mn,Al)₂Li₃Si₁₂O₃₀), cordierite ((Mg,Fe)₂ Al₃(Si₆AlO₁₈), tourmaline ((Na,Ca)(Al,Li,Mg)₃-(Al,Fe,Mn)₆ (Si₆O₁₈(BO₃)₃ (OH)₄), enstatite (MgSiO₃), ferrosilite (FeSiO₃), pigeonite (Ca_{0.25}(Mg,Fe)_{1.75}Si₂O₆), diopside (CaMgSi₂O₆), hedenbergite (CaFeSi₂O₆), augite ((Ca,Na)(Mg,Fe,Al) (Si,Al)₂O₆), jadeite (NaAlSi₂O₆), aegirine(acmite) (NaFe^{III}Si₂O₆), spodumene (LiAlSi₂O₅), wollastonite (CaSiO₃), rhodonite (MnSiO₃), pectolite (NaCa₂(Si₃O₈)(OH)), anthophyllite ((Mg,Fe)₇Si₈O₂₂(OH)₂), cummingtonite (Fe₂Mg₅Si₈O₂₂(OH)₂), grunerite (Fe₇Si₈O₂₂(OH)₂), tremolite (Ca₂Mg₅Si₈O₂₂(OH)₂), actinolite (Ca₂(Mg,Fe)₅Si₈O₂₂(OH)₂), hornblende ((Ca,Na)₂₋₃(Mg,Fe,Al)₅Si₈ (Al,Si)₂O₂₂ (OH)₂), glaucophane (Na₂Mg₃Al₂ Si₈O₂₂(OH)₂), riebeckite (asbestos) (Na₂Fe^{II}₃ Fe^{III}₂Si₈O₂₂(OH)₂), arfvedsonite (Na₃ (Fe,Mg)₄FeSi₆O₂₂(OH)₂), antigorite (Mg₃Si₂O₅(OH)₄), chrysotile (Mg₃Si₂O₅(OH)₄), lizardite (Mg₃Si₂O₅(OH)₄), halloysite (Al₂Si₂O₅(OH)₄), kaolinite (Al₂Si₂O₅(OH)₄), illite ((K,H₃O)(Al,Mg,Fe)₂ (Si,Al)₄O₁₀[(OH)₂,(H₂O)]), montmorillonite ((Na,Ca)_{0.33} (Al,Mg)₂ Si₄O₁₀(OH)₂⋅nH₂O), vermiculite ((MgFe,Al)₃(Al,Si)₄O₁₀(OH)₂⋅4H₂O), talc (Mg₃Si₄O₁₀ (OH)₂), sepiolite (Mg₄Si₆O₁₅(OH)₂⋅6H₂O), palygorskite (or attapulgite) ((Mg,Al)₂Si₄O₁₀ (OH)⋅4(H₂O)), pyrophyllite (Al₂Si₄O₁₀(OH)₂), biotite (K(Mg,Fe)₃(AlSi₃)O₁₀(OH)₂), muscovite (KAl₂(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), margarite (CaAl₂(Al₂Si₂)O₁₀(OH)₂), glauconite ((K,Na) (Al, Mg, Fe)₂(Si,Al)₄O₁₀(OH)₂), chlorite ((Mg, Fe)₃(Si,Al)₄O₁₀(OH)₂⋅(Mg, Fe)₃(OH)₆), quartz (SiO₂), tridymite (SiO₂), cristobalite (SiO₂), coesite (SiO₂), stishovite (SiO₂), microcline (KAlSi₃O₈), orthoclase (KAlSi₃O₃), anorthoclase ((Na,K)AlSi₃O₈), sanidine (KAlSi₃O₈), albite (NaAlSi₃O₈), oligoclase ((Na,Ca)(Si,Al)₄O₈(Na:Ca 4:1)), andesine ((Na,Ca)(Si,Al)₄O₈(Na:Ca 3:2)), labradorite ((Ca,Na)(Si,Al)₄O₈(Na:Ca 2:3)), bytownite ((Ca,Na)(Si,Al)₄O₈(Na:Ca 1:4)), anorthite (CaAl₂Si₂O₈), nosean (Na₈Al₆Si₆O₂₄(SO₄)), cancrinite (Na₆Ca₂(CO₃,Al₆Si₆O₂₄)⋅2H₂O), leucite (KAlSi₂O₆), nepheline ((Na,K) AlSiO₄), sodalite (Na₈(AlSiO₄)₆Cl₂), hauyne ((Na,Ca)₄₋₈Al₆Si₆(O,S)24(SO₄,Cl)₁₋₂), lazurite ((Na,Ca)₈(AlSiO₄)₆(SO₄,S,Cl)₂), petalite (LiAlSi₄O₁₀), marialite (Na₄ (AlSi₃O₈)₃(Cl₂,CO₃,SO₄)), meionite (Ca₄(Al₂Si₂O₈)₃ (Cl₂CO₃,SO₄)), analcime (NaAlSi₂O₆⋅H₂O), natrolite (Na₂Al₂Si₃ O₁₀⋅2H₂O), erionite ((Na₂,K₂,Ca)₂ Al₄Si₁₄O₃₆⋅15H₂O), chabazite (CaAl₂Si₄O₁₂⋅6H₂O), heulandite (CaAl₂Si₇O₁₈⋅6H₂O). stilbite (NaCa₂Al₅Si₁₃O₃₆⋅17H₂O), scolecite (CaAl₂Si₃O₁₀⋅3H₂O), and mordenite ((Ca, Na₂; K₂)Al₂Si₁₀O₂₄⋅7H₂O).

In other embodiments the mineral additive may include a carbon black, an amorphous carbon, a graphite, a graphene, a carbon nanotube, a fullerene, or a mixture thereof.

In some embodiments the composition may include the polymer, the additive and a filler material. Suitable filler materials may include, for example, at least one selected from a silica, an alumina, a wood flour, a gypsum, a talc, a mica, a carbon black, a montmorillonite mineral, a chalk, a diatomaceous earth, a sand, a gravel, a crushed rock, bauxite, limestone, sandstone, an aerogel, a xerogel, a microsphere, a porous ceramic sphere, a gypsum dihydrate, calcium aluminate, magnesium carbonate, a ceramic material, a pozzolanic material, a zirconium compound, a crystalline calcium silicate gel, a perlite, a vermiculite, a cement particle, a pumice, a kaolin, a titanium dioxide, an iron oxide, calcium phosphate, barium sulfate, sodium carbonate, magnesium sulfate, aluminum sulfate, magnesium carbonate, barium carbonate, calcium oxide, magnesium oxide, aluminum hydroxide, calcium sulfate, barium sulfate, lithium fluoride, a polymer particle, a powdered metal, a pulp powder, a cellulose, a starch, a lignin powder, a chitin, a chitosan, a keratin, a gluten, a nut shell flour, a wood flour, a corn cob flour, calcium carbonate, calcium hydroxide, a glass bead, a hollow glass bead, a seagel, a cork, a seed, a gelatin, a wood flour, a saw dust, an agar-based material, a glass fiber, a natural fibers, and mixtures thereof, just to name a few.

Particular compositions of the present disclosure include, for example, compositions containing a thermoplastic polymer having a specific heat that is equal to or greater than 1900 J/kg⋅K, and an additive such that the specific heat of the composition is equal to or less than 1800 J/kg⋅K. In other embodiments, for example, the composition may include a thermoplastic polymer having a specific heat that is equal to or greater than 1950 J/kg⋅K, or or greater than 2000 J/kg⋅K, or greater than 2050 J/kg⋅K, or greater than 2100 J/kg⋅K, and an additive such that the specific heat of the compositions is equal to or less than 1900 J/kg⋅K, or equal to or less than 1850 J/kg⋅K, or equal to or less than 1800 J/kg⋅K, or equal to or less than 1750 J/kg⋅K, or equal to or less than 1700 J/kg⋅K, or equal to or less than 1650 J/kg⋅K, or equal to or less than 1600 J/kg⋅K.

In some embodiments the compositions include a thermoplastic polymer and a mineral additive, wherein a proportion of the mineral additive is set such that the specific heat of the composition is equal to or less than 90% of the specific heat of the thermoplastic polymer. In some compositions of the present disclosure the proportion of the mineral additive in the composition ranges from 1 percent by weight to 80 percent by weight, or from 5 percent by weight to 75 percent by weight, or from 10 percent by weight to 70 percent by weight, or from 15 percent by weight to 65 percent by weight, or from 20 percent by weight to 60 percent by weight, relative to a combined weight of the thermoplastic polymer and the mineral additive. In some embodiments the composition comprises 50-93 wt. % of the thermoplastic polymer, and 7-50 wt. % of the mineral additive, relative to a total weight of the composition.

Methods for Producing Compositions for Fused Filament Fabrication

Some embodiments relate to a method for producing a composition for fused filament fabrication, including the steps of: (1) selecting a polymer capable of undergoing material extrusion to form a semiliquid; (2) measuring a specific heat of the thermoplastic polymer; (3) combining the polymer with a additive to obtain a composite material; (4) measuring a specific heat of the composite material; and (5) adjusting a proportion of the additive in the composite material to obtain a composition having a specific heat that is equal to or less than 95% of the specific heat of the polymer.

In some embodiments the composition may be formulated such that a proportion of the additive in the composition is set such that the specific heat of the composition is equal to or less than 90%, or equal to or less than 85%, or equal to or less than 80%, or equal to or less than 75%, or equal to or less than 70%, or equal to or less than 65%, or equal to or less than 60%, of the specific heat of the polymer,

In some embodiments the method for producing a composition is conducted such that the polymer is a thermoplastic polymer as described above, and the additive is a mineral additive as described above. The thermoplastic polymer may include, for example, a polyolefin such as a random or block co-polyolefin,

In some embodiments the method for producing a composition involves the use of a thermoplastic polymer having a density of equal to or less than 0.9 g/cm³. Embodiments may also involve the use of a thermoplastic polymer having a crystallization temperature of equal to or less than 70° C. at a cooling rate of 20° C. per minute. The method for producing a composition may be performed in a manner such that the specific heat of the thermoplastic polymer is equal to or greater than 1900 J/kg⋅K, and the specific heat of the composition is equal to or less than 1800 J/kg⋅K.

In some embodiments the base polymer is a thermoplastic polymer having a density of equal to or less than 0.9 g/cm³. In other embodiments the density of the thermoplastic polymer may be equal to or less than 0.85 g/cm³, or equal to or less than 0.80 g/cm³, or equal to or less than 0.75 g/cm³, or equal to less or than 0.70 g/cm³. In some embodiments the base polymer is in the form of a crystalline, semi-crystalline or amorphous polymer, such as for example, a crystalline, semi-crystalline or amorphous thermoplastic polymer. For example, some compositions of the present disclosure contain, as the base polymer, a thermoplastic polymer having a crystallization temperature of equal to or less than 70° C. at a cooling rate of 20° C. per minute. In other embodiments, compositions of the present disclosure may contain, as the base polymer, a thermoplastic polymer having a crystallization temperature of equal to or less than 65° C., or equal to or less than 60° C., or equal to or less than 55° C., or equal to or less than 50° C., at a cooling rate of 20° C. per minute.

In some embodiments the method for producing a composition may be carried out such that a proportion of the mineral additive in the composition is set such that the specific heat of the composition is equal to or less than 90% of the specific heat of the thermoplastic polymer. The proportion of the mineral additive in the composition may range from 1 percent by weight to 80 percent by weight, relative to a combined weight of the thermoplastic polymer and the mineral additive. For instance, in some embodiments, the resulting composition comprises 50-93 wt. % of the thermoplastic polymer and 7-50 wt. % of the mineral additive, relative to a total weight of the composition.

Embodiments of the method for producing compositions for fused filament fabrication may also include an additional step of adding, as an additional polymer, a natural or synthetic polymer that is different from the base polymer, to the composite material. For example, some embodiments may include an additional step of adding an elastomer to the composite material, said elastomer being different than the base polymer.

In some embodiments of the method for producing compositions the additive may include a mineral additive containing at least one selected from an inorganic mineral, an allotrope of carbon, and an organic polymer. For example, the mineral additive may include at least one selected from a silicate, an aluminosilicate, a diatomaceous earth, a perlite, a pumicite, a natural glass, a cellulose, an activated charcoal, a feldspar, a zeolite, a mica, a talc, a clay, a kaolin, a smectite, a wollastonite, a bentonite, and combinations thereof, just to name a few. The mineral additive may also include a carbon black, an amorphous carbon, a graphite, a graphene, a carbon nanotube, a fullerene, or a mixture thereof.

In some embodiments the method for producing the composition may include an additional step of adding a filler material to the composite material. Such a filler material may include the filler materials above, or other filler materials known in the relevant art. The present disclosure also includes compositions produced by the method for producing a composition for fused filament extrusion.

### Additive Manufacturing Processes

Some embodiments relate to an additive manufacturing process, including the steps of: melting the composition for additive manufacturing described above to form a molten mixture; delivering the molten mixture onto a working surface to obtain a molten deposit on the working surface; and allowing the molten deposit to solidify to obtain a composite material in the form of a section plane of an object. In some embodiments shapes and contents of the section plane are defined at least in part by respective shapes and contents of the molten deposit. The additive manufacturing process may also include the steps of repeating the melting and delivering steps for successive section planes to fabricate the object. Embodiments of the present disclosure also include objects formed by the additive manufacturing process described above.

Some embodiments relate to an additive manufacturing process, including the steps of: melting a solid mixture containing a polyolefin and a mineral additive, to form a molten mixture; delivering the molten mixture onto a working surface at a fill angle relative to a plane of the working surface, to obtain a molten deposit on the working surface; allowing the molten deposit to solidify to obtain a composite material in the form of a section plane of an object; and repeating the melting and delivering steps for successive section planes to fabricate an object, wherein: a proportion of the mineral additive in the solid mixture is adjusted such that equation (1) below is satisfied:)

TS(90°)≥0.75×TS(0°) (1),

in which TS(90°) represents a tensile stress at yield point of an object B formed by delivering the molten mixture onto the working surface at a fill angle of 90°, and TS(0°) represents a tensile stress at yield point of an object A formed by delivering the molten mixture onto the working surface at a fill angle of 0°.

In some embodiments the additive manufacturing processes are carried out using a thermplastic polyolefin, such as for example a random or block co-polyolefin. The polyolefin may have a density of equal to or less than 0.9 g/cm³ and/or the polyolefin may have a crystallization temperature of equal to or less than 70° C. at a cooling rate of 20° C. per minute. In some embodiments the additive manufacturing processes are carried out such that the specific heat of the polyolefin is equal to or greater than 1900 J/kg⋅K, and the specific heat of the solid mixture is equal to or less than 1800 J/kg⋅K.

A proportion of the mineral additive used in the additive manufacturing processes above may be controlled such that the proportion of the mineral additive in the solid mixture is set such that the specific heat of the solid mixture is equal to or less than 90% of the specific heat of the thermoplastic polyolefin. In some embodiments the proportion of the mineral additive in the solid mixture ranges from 1 percent by weight to 80 percent by weight, relative to a combined weight of the thermoplastic polyolefin and the mineral additive. For instance, the solid mixture may include: 50-93 wt. % of the polyolefin; and 7-50 wt. % of the mineral additive, relative to a total weight of the solid mixture.

Embodiments of the additive manufacturing processes above may include an additional step of adding, as an additional polymer, a natural or synthetic polymer that is different from the polyolefin, to the solid mixture. For instance, the additive manufacturing process may include the additional step of adding an elastomer to the solid mixture, said elastomer being different from the polyolefin.

In the additive manufacturing processes above the mineral additive may include an inorganic mineral, an allotrope of carbon, an organic polymer, or any combination thereof. For instance, the mineral additive may be at least one selected from a silicate, an aluminosilicate, a diatomaceous earth, a perlite, a pumicite, a natural glass, a cellulose, an activated charcoal, a feldspar, a zeolite, a mica, a talc, a clay, a kaolin, a smectite, a wollastonite, a bentonite, and combinations thereof, just to name a few. In other embodiments the mineral additive may include a carbon black, an amorphous carbon, a graphite, a graphene, a carbon nanotube, a fullerene, or a mixture thereof.

The additive manufacturing processes above may be conducted such that the solid mixture further includes a filler material that is different from the mineral additive. Suitable filler materials include the filler materials disclosed above. Embodiments of the present disclosure also include objects formed by the additive manufacturing process above.

Embodiments of the present disclosure also include an additive manufacturing process, including the steps of: separately metering the thermoplastic polymer and the mineral additive into a material extrusion nozzle, and melting a resulting mixture to obtain a molten mixture; delivering the molten mixture onto a surface to obtain a molten deposit that solidifies into a section plane of an object; and repeating the metering, melting and delivering steps for successive section planes to fabricate the object.

Embodiments of the process above may be conducted such that a mixing ratio of the mineral additive to the thermoplastic polymer is controlled such that at least one of the following conditions is satisfied: (i) a warpage of the object is less than a warpage of an object fabricated by repeatedly performing the melting and delivering steps with the thermoplastic polymer in the absence of the mineral additive; (ii) a tensile stress at yield point of the object is less than a tensile stress at yield point of an object fabricated by repeatedly performing the melting and delivering steps with the thermoplastic polymer in the absence of the mineral additive; (iii) a tensile stress at filament failure point of the object is less than a tensile stress at filament failure point of an object fabricated by repeatedly performing the melting and delivering steps with the thermoplastic polymer in the absence of the mineral additive; (iv) a modulus of elasticity of the object is less than a modulus of elasticity of an object fabricated by repeatedly performing the melting and delivering steps with the thermoplastic polymer in the absence of the mineral additive; and (v) a void space of the object is less than a void space of an object fabricated by repeatedly performing the melting and delivering steps with the thermoplastic polymer in the absence of the mineral additive. In some embodiments the process above may be conducted such that the mixing ratio is controlled such that the specific heat of the resulting mixture is equal to or less than 90% of the specific heat of the thermoplastic polymer. Embodiments of the present disclosure also include objects formed by the process above.

Objects formed using the additive manufacturing processes above can exhibit improved properties relative to objects formed by additive manufacturing using compositions that do not contain the required additive of the present disclosure. For example, objects formed using the additive manufacturing processes above can exhibit improved coalescence and adhesion of the individual layers (i.e., “roads”) of the object. Such improved coalescence and adhesion can occur due to a lower void space (e.g., lower porosity)—relative to objects formed using compositions that do not contain the required additive of the present disclosure. Objects formed using the additive manufacturing processes above can also exhibit improved physical properties such as improved angular consistency. For example, objects formed using the additive manufacturing processes above can exhibit consistent physical properties at fill angles of 0° and 90°. Objects formed using the additive manufacturing processes above can also exhibit improved warpage properties relative to objects formed using compositions that do not contain the required additive of the present disclosure.

### EMBODIMENTS

Embodiment [1] of the present disclosure relates to a composition for additive manufacturing, the composition comprising: a thermoplastic polymer; and a mineral additive capable of reducing a specific heat of the composition relative to a specific heat of the thermoplastic polymer, wherein: a proportion of the mineral additive in the composition is set such that the specific heat of the composition is equal to or less than 95% of the specific heat of the thermoplastic polymer; the composition is in the form of a filament, rod, pellet or granule; and the composition is adapted to function as a composition suitable for performing additive manufacturing by material extrusion.

Embodiment [2] of the present disclosure relates to the composition of Embodiment [1], wherein the thermoplastic polymer comprises a polyolefin.

Embodiment [3] of the present disclosure relates to the composition of Embodiments [1 ]-[2], wherein the thermoplastic polymer comprises a random or block co-polyolefin.

Embodiment [4] of the present disclosure relates to the composition of Embodiments [1]-[3], wherein the thermoplastic polymer comprises a random or block co-polypropylene.

Embodiment [5] of the present disclosure relates to the composition of Embodiments [1]-[4], further comprising, as an additional polymer, a natural or synthetic polymer that is different from the thermoplastic polymer.

Embodiment [6] of the present disclosure relates to the composition of Embodiments [1]-[5], further comprises at least one additional polymer selected from the group consisting of a polyamide, a polycarbonate, a polyimide, a polyurethane, a polyalkylenemine, a polyoxyalkylene, a polyester, a polyacrylate, a polylactic acid, a polysiloxane, a polyolefin and copolymers and blends thereof,

Embodiment [7] of the present disclosure relates to the composition of Embodiments [1]-[6], further comprising an elastomer that is different from the thermoplastic polymer,

Embodiment [8] of the present disclosure relates to the composition of Embodiments [1]-[7], wherein the thermoplastic polymer has a density of equal to or less than 0.9 g/cm³.

Embodiment [9] of the present disclosure relates to the composition of Embodiments [1]-[8], wherein the thermoplastic polymer is a crystalline, semi-crystalline or amorphous polymer.

Embodiment [10] of the present disclosure relates to the composition of Embodiments [1]-[9], wherein the thermoplastic polymer has a crystallization temperature of equal to or less than 70° C. at a cooling rate of 20° C. per minute.

Embodiment [11] of the present disclosure relates to the composition of Embodiments [1]-[10], wherein the mineral additive comprises at least one selected from the group consisting of an inorganic mineral, an allotrope of carbon, and an organic polymer.

Embodiment [12] of the present disclosure relates to the composition of Embodiments [1]-[11], wherein the mineral additive comprises at least one selected from the group consisting of a silicate, an aluminosilicate, a diatomaceous earth, a perlite, a pumicite, a natural glass, a cellulose, an activated charcoal, a feldspar, a zeolite, a mica, a talc, a clay, a kaolin, a smectite, a wollastonite, a bentonite, and combinations thereof.

Embodiment [13] of the present disclosure relates to the composition of Embodiments [1]-[12], wherein the mineral additive comprises at least one inorganic mineral selected from the group consisting of phenakite (Be₂SiO₄), willemite (Zn₂SiO₄), forsterite (Mg₂SiO₄), fayalite (Fe₂SiO₄), tephroite (Mn₂SiO₄). pyrope (Mg₃Al₂(SiO₄)₃), almandine (Fe₃Al₂(SiO₄)₃), spessartine (Mn₃Al₂(SiO₄)₃), grossular (Ca₃Al₂(SiO₄)₃), andradite (Ca₃Fe₂(SiO₄)₃), uvarovite (Ca₃Cr₂(SiO₄)₃), hydrogrossular (Ca₃Al₂Si₂O₈(SiO₄)₃₋ₘ(OH)₄), zircon (ZrSiO₄), thorite ((Th,U)SiO₄), perlite (Al₂SiO₅), andalusite (Al₂SiO₅), kyanite (Al₂SiO₅), sillimanite (Al₂SiO₅), dumortierite (Al_{6.5-7}BO₃(SiO₄)₃(O,OH)₃), topaz (Al₂SiO₄(F,OH)₂), staurolite (Fe₂Al₉(SiO₄)₄(O,OH)₂), humite ((Mg,Fe)₇(SiO₄)₃(F,OH)₂), norbergite (Mg₃(SiO₄)(F,OH)₂), chondrodite (Mg₅(SiO₄)₂(F,OH)₂), humite (Mg₇(SiO₄)₃ (F,OH)₂), clinohumite (Mg,(SiO₄)₄(F,OH)₂), datolite (CaBSiO₄(OH)), titanite (CaTiSiO₅), chloritoid ((Fe,Mg,Mn)₂Al₄Si₂O₁₀(OH)₄), mullite (aka Porcelainite)(Al₆Si₂O₁₃), hemimorphite (calamine) (Zn₄(Si₂O₇)(OH)₂H₂O), lawsonite (CaAl₂(Si₂O₇)(OH)₂⋅H₂O), ilvaite (CaFe^{II}₂Fe^{III}O(Si₂O₇)(OH)), epidote (Ca₂(Al,Fe)₃O(SiO₄)(Si₂O₇)(OH)), zoisite (Ca₂Al₃O(SiO₄)(Si₂O₇)(OH)), clinozoisite (Ca₂Al₃O(SiO₄(Si₂O₇)(OH)), tanzanite (Ca₂Al₃O(SiO₄) (Si₂O₇)(OH)), allanite (Ca(Ce,La,Y,Ca)Al₂(Fe^{II},Fe^{III})O(SiO₄)(Si₂O₇)(OH)), dollaseite (Ce)(CaCeMg₂Al Si₃O₁₁F(OH)), vesuvianite (idocrase) (Ca₁₀(Mg ,Fe)₂Al₄(SiO₄)₅ (Si₂O₇)₂(OH)₄), benitoite (BaTi(Si₃O₉), axinite ((Ca,Fe,Mn)₃Al₂(BO₃)(Si₄O₁₂)(OH), beryl/emerald (Be₃Al₂(Si₆O₁₈), sugilite (KNa₂(Fe, Mn, Al)₂Li₃Si₁₂O₃₀), cordierite ((Mg Fe)₂ Al₃(Si₅AlO₁₈), tourmaline ((Na,Ca)(Al,Li,Mg)₃-(Al,Fe,Mn)₆ (Si₆O₁₈(BO₃)₃ (OH)₄), enstatite (MgSiO₃), ferrosilite (FeSiO₃), pigeonite (Ca_{0.25}(Mg,Fe)_{1.75}Si₂O₆), diopside (CaMgSi₂O₆), hedenbergite (CaFeSi₂O₆), augite ((Ca,Na)(Mg,Fe,Al) (Si,Al)₂O₆), jadeite (NaAlSi₂O₆), aegirine(acmite) (NaFe^{III}Si₂O₆), spodumene (LiAlSi₂O₆), wollastonite (CaSiO₃), rhodonite (MnSiO₃), pectolite (NaCa₂(Si₃O₈)(OH)), anthophyllite ((Mg ,Fe)₇Si₈O₂₂(OH)₂), cummingtonite (Fe₂Mg₅Si₈O₂₂(OH)₂), grunerite (Fe₇Si₈O₂₂(OH)₂), tremolite (Ca₂Mg₅Si₈O₂₂(OH)₂), actinolite (Ca₂(Mg,Fe)₅Si₃O₂₂(OH)₂), hornblende ((Ca,Na)₂₋₃(Mg,Fe,Al)₅Si₆ (Al,Si)₂O₂₂ (OH)₂), glaucophane (Na₂Mg₃Al₂ Si₃O₂₂(OH)₂), riebeckite (asbestos) (Na₂Fe^{II}₃Fe^{III}₂Si₈O₂₂(OH)₂), arfvedsonite (Na₃ (Fe,Mg)₄FeSi₈O₂₂(OH)₂), antigorite (Mg₃Si₂O₅(OH)₄), chrysotile (Mg₃Si₂O₅(OH)₄), lizardite (Mg₃Si₂O₅(OH)₄), halloysite (Al₂Si₂O₅(OH)₄), kaolinite (Al₂Si₂O₅(OH)₄), illite ((K,H₃O)(Al,Mg,Fe)₂ (Si,Al)₄ O₁₀[(OH)₂,(H₂O)]), montmorillonite ((Na,Ca)_{0.33} (Al,Mg)₂ Si₄O₁₀(OH)₂⋅nH₂O), vermiculite ((MgFe,Al)₃(Al,Si)₄O₁₀(OH)₂⋅4H₂O), talc (Mg₃Si₄O₁₀ (OH)₂), sepiolite (Mg₄Si₆O₁₅(OH)₂⋅6H₂O), palygorskite (or attapulgite) ((Mg,Al)₂Si₄O₁₀ (OH)⋅4(H₂O)), pyrophyllite (Al₂Si₄O₁₀(OH)₂), biotite (K(Mg,Fe)₃(AlSi₃)O₁₀(OH)₂), muscovite (KAl₂(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), margarite (CaAl₂(Al₂Si₂)O₁₀(OH)₂), glauconite ((K,Na) (Al, Mg, Fe)₂(Si,Al)₄O₁₀(OH)₂), chlorite ((Mg, Fe)₃(Si,Al)₄O₁₀(OH)₂⋅(Mg, Fe)₃(OH)₆), quartz (SiO₂), tridymite (SiO₂), cristobalite (SiO₂), coesite (SiO₂), stishovite (SiO₂), microcline (KAlSi₃O₈), orthoclase (KAlSi₃O₈), anorthoclase ((Na,K)AlSi₃O₈), sanidine (KAlSi₃O₈), albite (NaAlSi₃O₈), oligoclase ((Na,Ca)(Si,Al)₄O₈(Na:Ca 4:1)), andesine ((Na,Ca)(Si,Al)₄O₈(Na:Ca 3:2)), labradorite ((Ca,Na)(Si,Al)₄O₈(Na:Ca 2:3)), bytownite ((Ca,Na)(Si,Al)₄O₈(Na:Ca 1:4)), anorthite (CaAl₂Si₂O₈), nosean (Na₆Al₆Si₆O₂₄(SO₄)). cancrinite (Na₆Ca₂(CO₃,Al₆Si₆O₂₄)⋅2H₂O), leucite (KAlSi₂O₆), nepheline ((Na,K) AlSiO₄), sodalite (Na₈(AlSiO₄)₆Cl₂), hauyne ((Na,Ca)₄₋₈Al₆Si₆(O,S)24(SO₄,Cl)₁₋₂), lazurite ((Na,Ca)₈(AlSiO₄)₆(SO₄,S,Cl)₂), petalite (LiAlSi₄O₁₀), marialite (Na₄(AlSi₃O₈)₃(Cl₂,CO₃,SO₄)), meionite (Ca₄(Al₂Si₂O₈)₃ (Cl₂CO₃,SO₄)), analcime (NaAlSi₂O₆H₂O), natrolite (Na₂Al₂Si₃ O₁₀.2H₂O), erionite ((Na₂,K₂,Ca)₂ Al₄Si₁₄O₃₆⋅15H₂O), chabazite (CaAl₂Si₄O₁₂⋅6H₂O), heulandite (CaAl₂Si₇O₁₈⋅6H₂O), stilbite (NaCa₂Al₅Si₁₃O₃₆⋅17H₂O), scolecite (CaAl₂Si₃O₁₀⋅3H₂O), and mordenite ((Ca,Na₂,K₂)Al₂Si₁₀O₂₄⋅7H₂O).

Embodiment [14] of the present disclosure relates to the composition of Embodiments [1]-[13], wherein the mineral additive comprises a carbon black, an amorphous carbon, a graphite, a graphene, a carbon nanotube, a fullerene, or a mixture thereof.

Embodiment [15] of the present disclosure relates to the composition of Embodiments [1]-[14], further comprising a filler material.

Embodiment [16] of the present disclosure relates to the composition of Embodiments [1]-[15], further comprising at least one filler material selected from the group consisting of a silica, an alumina, a wood flour, a gypsum, a talc, a mica, a carbon black, a montmorillonite mineral, a chalk, a diatomaceous earth, a sand, a gravel, a crushed rock, bauxite, limestone, sandstone, an aerogel, a xerogel, a microsphere, a porous ceramic sphere, a gypsum dihydrate, calcium aluminate, magnesium carbonate, a ceramic material, a pozzolamic material, a zirconium compound, a crystalline calcium silicate gel, a perlite, a vermiculite, a cement particle, a pumice, a kaolin, a titanium dioxide, an iron oxide, calcium phosphate, barium sulfate, sodium carbonate, magnesium sulfate, aluminum sulfate, magnesium carbonate, barium carbonate, calcium oxide, magnesium oxide, aluminum hydroxide, calcium sulfate, barium sulfate, lithium fluoride, a polymer particle, a powdered metal, a pulp powder, a cellulose, a starch, a lignin powder, a chitin, a chitosan, a keratin, a gluten, a nut shell flour, a wood flour, a corn cob flour, calcium carbonate, calcium hydroxide, a glass bead, a hollow glass bead, a seagel, a cork, a seed, a gelatin, a wood flour, a saw dust, an agar-based material, a glass fiber, a natural fibers, and mixtures thereof.

Embodiment [17] of the present disclosure relates to the composition of Embodiments [1]-[16], wherein: the specific heat of the thermoplastic polymer is equal to or greater than 1900 J/kg⋅K; and the specific heat of the composition is equal to or less than 1800 J/kg⋅K.

Embodiment [18] of the present disclosure relates to the composition of Embodiments [1]-[17], wherein the proportion of the mineral additive in the composition is set such that the specific heat of the composition is equal to or less than 90% of the specific heat of the thermoplastic polymer.

Embodiment [19] of the present disclosure relates to the composition of Embodiments [1]-[18], wherein the proportion of the mineral additive in the composition ranges from 1 percent by weight to 80 percent by weight, relative to a combined weight of the thermoplastic polymer and the mineral additive.

Embodiment [20] of the present disclosure relates to the composition of Embodiments [1]-[19], comprising: 50-93 wt. % of the thermoplastic polymer; and 7-50 wt. % of the mineral additive, relative to a total weight of the composition.

Embodiment [21] of the present disclosure relates to an additive manufacturing process, comprising: melting the composition of Embodiment [1] to form a molten mixture; delivering the molten mixture onto a working surface to obtain a molten deposit on the working surface; and allowing the molten deposit to solidify to obtain a composite material in the form of a section plane of an object.

Embodiment [22] of the present disclosure relates to the additive manufacturing process of Embodiment [21], wherein shapes and contents of the section plane are defined at least in part by respective shapes and contents of the molten deposit.

Embodiment [23] of the present disclosure relates to the additive manufacturing process of Embodiments [21]-[22], further comprising: repeating the melting and delivering steps for successive section planes to fabricate the object.

Embodiment [24] relates to an object formed by the additive manufacturing process of Embodiments [21]-[23].

Embodiment [25] of the present disclosure relates to a method for producing a composition for fused filament fabrication, the method comprising: (1) selecting a thermoplastic polymer capable of undergoing material extrusion to form a semiliquid; (2) measuring a specific heat of the thermoplastic polymer; (3) combining the thermoplastic polymer with a mineral additive to obtain a composite material; (4) measuring a specific heat of the composite material; and (5) adjusting a proportion of the mineral additive in the composite material to obtain a composition having a specific heat that is equal to or less than 95% of the specific heat of the thermoplastic polymer.

Embodiment [26] of the present disclosure relates to the method of Embodiment [25], wherein the thermoplastic polymer comprises a polyolefin.

Embodiment [27] of the present disclosure relates to the method of Embodiments [25]-[26], wherein the thermoplastic polymer comprises a random or block co-polyolefin.

Embodiment [28] of the present disclosure relates to the method of Embodiments [25]-[27], wherein the thermoplastic polymer has a density of equal to or less than 0.9 g/cm³.

Embodiment [29] of the present disclosure relates to the method of Embodiments [25]-[28], wherein the thermoplastic polymer has a crystallization temperature of equal to or less than 70° C. at a cooling rate of 20° C. per minute.

Embodiment [30] of the present disclosure relates to the method of Embodiments [25]-[29], wherein: the specific heat of the thermoplastic polymer is equal to or greater than 1900 J/kg⋅K; and the specific heat of the composition is equal to or less than 1800 J/kg⋅K.

Embodiment [31] of the present disclosure relates to the method of Embodiments [25]-[30], wherein the proportion of the mineral additive in the composition is set such that the specific heat of the composition is equal to or less than 90% of the specific heat of the thermoplastic polymer.

Embodiment [32] of the present disclosure relates to the method of Embodiments [25]-[31], wherein the proportion of the mineral additive in the composition ranges from 1 percent by weight to 80 percent by weight, relative to a combined weight of the thermoplastic polymer and the mineral additive.

Embodiment [33] of the present disclosure relates to the method of Embodiments [25]-[32], wherein the composition comprises: 50-93 wt. % of the thermoplastic polymer; and 7-50 wt. % of the mineral additive, relative to a total weight of the composition.

Embodiment [34] of the present disclosure relates to the method of Embodiments [25]-[33], further comprising adding, as an additional polymer, a natural or synthetic polymer that is different from the thermoplastic polymer, to the composite material.

Embodiment [35] of the present disclosure relates to the method of Embodiments [25]-[34], further comprising adding an elastomer to the composite material, said elastomer being different than the thermoplastic polymer.

Embodiment [36] of the present disclosure relates to the method of Embodiments [25]-[35], wherein the mineral additive comprises at least one selected from the group consisting of an inorganic mineral, an allotrope of carbon, and an organic polymer.

Embodiment [37] of the present disclosure relates to the method of Embodiments [25]-[36], wherein the mineral additive comprises at least one selected from the group consisting of a silicate, an aluminosilicate, a diatomaceous earth, a perlite, a pumicite, a natural glass, a cellulose, an activated charcoal, a feldspar, a zeolite, a mica, a talc, a clay, a kaolin, a smectite, a wollastonite, a bentonite, and combinations thereof.

Embodiment [38] of the present disclosure relates to the method of Embodiments [25]-[37], wherein the mineral additive comprises a carbon black, an amorphous carbon, a graphite, a graphene, a carbon nanotube, a fullerene, or a mixture thereof.

Embodiment [39] of the present disclosure relates to the method of Embodiments [25]-[38], further comprising adding a filler material to the composite material.

Embodiment [40] of the present disclosure relates to a composition produced by the method of Embodiments [25]-[39].

Embodiment [41] of the present disclosure relates to an additive manufacturing process, comprising: melting a solid mixture containing a polyolefin and a mineral additive, to form a molten mixture; delivering the molten mixture onto a working surface at a fill angle relative to a plane of the working surface, to obtain a molten deposit on the working surface; allowing the molten deposit to solidify to obtain a composite material in the form of a section plane of an object; and repeating the melting and delivering steps for successive section planes to fabricate an object, wherein: a proportion of the mineral additive in the solid mixture is adjusted such that equation (1) below is satisfied:)

TS(90°)≥0.75×TS(0°) (1);

TS(90°) represents a tensile stress at yield point of an object B formed by delivering the molten mixture onto the working surface at a fill angle of 90°; and TS(0°) represents a tensile stress at yield point of an object A formed by delivering the molten mixture onto the working surface at a fill angle of 0°.

Embodiment [42] of the present disclosure relates to the process of Embodiment [41], wherein the polyolefin is a thermplastic polyolefin.

Embodiment [43] of the present disclosure relates to the process of Embodiments [41]-[42], wherein the polyolefin comprises a random or block co-polyolefin.

Embodiment [44] of the present disclosure relates to the process of Embodiments [41]-[43], wherein the polyolefin has a density of equal to or less than 0.9 g/cm³.

Embodiment [45] of the present disclosure relates to the process of Embodiments [41]-[44], wherein the polyolefin has a crystallization temperature of equal to or less than 70° C. at a cooling rate of 20° C. per minute.

Embodiment [46] of the present disclosure relates to the process of Embodiments [41]-[45], wherein: the specific heat of the polyolefin is equal to or greater than 1900 J/kg⋅K; and the specific heat of the solid mixture is equal to or less than 1800 J/kg⋅K.

Embodiment [47] of the present disclosure relates to the process of Embodiments [41]-[46], wherein the proportion of the mineral additive in the solid mixture is set such that the specific heat of the solid mixture is equal to or less than 90% of the specific heat of the thermoplastic polyolefin.

Embodiment [48] of the present disclosure relates to the process of Embodiments [41]-[47], wherein the proportion of the mineral additive in the solid mixture ranges from 1 percent by weight to 80 percent by weight, relative to a combined weight of the thermoplastic polyolefin and the mineral additive.

Embodiment [49] of the present disclosure relates to the process of Embodiments [41]-[48], wherein the solid mixture comprises: 50-93 wt. % of the polyolefin; and 7-50 wt. % of the mineral additive, relative to a total weight of the solid mixture.

Embodiment [50] of the present disclosure relates to the process of Embodiments [41]-[49], further comprising adding, as an additional polymer, a natural or synthetic polymer that is different from the polyolefin, to the solid mixture.

Embodiment [51] of the present disclosure relates to the process of Embodiments [41]-[50], further comprising adding an elastomer to the solid mixture, said elastomer being different from the polyolefin.

Embodiment [52] of the present disclosure relates to the process of Embodiments [41]-[51], wherein the mineral additive comprises at least one selected from the group consisting of an inorganic mineral, an allotrope of carbon, and an organic polymer,

Embodiment [53] of the present disclosure relates to the process of Embodiments [41]-[52], wherein the mineral additive comprises at least one selected from the group consisting of a silicate, an aluminosilicate, a diatomaceous earth, a perlite, a pumicite, a natural glass, a cellulose, an activated charcoal, a feldspar, a zeolite, a mica, a talc, a clay, a kaolin, a smectite, a wollastonite, a bentonite, and combinations thereof

Embodiment [54] of the present disclosure relates to the process of Embodiments [41]-[53], wherein the mineral additive comprises a carbon black, an amorphous carbon, a graphite, a graphene, a carbon nanotube, a fullerene, or a mixture thereof.

Embodiment [55] of the present disclosure relates to the process of Embodiments [41]-[54], wherein the solid mixture further comprises a filler material.

Embodiment [56] of the present disclosure relates to an object formed by the process of Embodiments [41]-[55].

Embodiment [57] of the present disclosure relates to an additive manufacturing process, comprising: separately metering a thermoplastic polymer and a mineral additive into a material extrusion nozzle, and melting a resulting mixture to obtain a molten mixture; delivering the molten mixture onto a surface to obtain a molten deposit that solidifies into a section plane of an object; and repeating the metering, melting and delivering steps for successive section planes to fabricate the object, wherein a mixing ratio of the mineral additive to the thermoplastic polymer is controlled such that at least one of the following conditions is satisfied; (i) a warpage of the object is less than a warpage of an object fabricated by repeatedly performing the melting and delivering steps with the thermoplastic polymer in the absence of the mineral additive; (ii) a tensile stress at yield point of the object is less than a tensile stress at yield point of an object fabricated by repeatedly performing the melting and delivering steps with the thermoplastic polymer in the absence of the mineral additive; (iii) a tensile stress at filament failure point of the object is less than a tensile stress at filament failure point of an object fabricated by repeatedly performing the melting and delivering steps with the thermoplastic polymer in the absence of the mineral additive; (iv) a modulus of elasticity of the object is less than a modulus of elasticity of an object fabricated by repeatedly performing the melting and delivering steps with the thermoplastic polymer in the absence of the mineral additive; and (v) a void space of the object is less than a void space of an object fabricated by repeatedly performing the melting and delivering steps with the thermoplastic polymer in the absence of the mineral additive.

Embodiment [58] of the present disclosure relates to the process of Embodiment [57], wherein the thermoplastic polymer is a polyolefin.

Embodiment [59] of the present disclosure relates to the process of Embodiments [57]-[58], wherein the thermoplastic polymer comprises a random or block co-polyolefin.

Embodiment [60] of the present disclosure relates to the process of Embodiments [57]-[59], wherein the thermoplastic polymer has a density of equal to or less than 0.9 g/cm³.

Embodiment [61] of the present disclosure relates to the process of Embodiments [57]-[60], wherein the thermoplastic polymer has a crystallization temperature of equal to or less than 70° C. at a cooling rate of 20° C. per minute.

Embodiment [62] of the present disclosure relates to the process of Embodiments [57]-[61], wherein: the specific heat of the thermoplastic polymer is equal to or greater than 1900 J/kg⋅K; and the specific heat of the resulting mixture is equal to or less than 1800 J/kg⋅K.

Embodiment [63] of the present disclosure relates to the process of Embodiments [57]-[62], wherein the mixing ratio is controlled such that the specific heat of the resulting mixture is equal to or less than 90% of the specific heat of the thermoplastic polymer.

Embodiment [64] of the present disclosure relates to the process of Embodiments [57]-[63], wherein the proportion of the mineral additive in the resulting mixture ranges from 1 percent by weight to 80 percent by weight, relative to a combined weight of the thermoplastic polymer and the mineral additive.

Embodiment [65] of the present disclosure relates to the process of Embodiments [57]-[64], wherein the resulting mixture comprises: 50-93 wt. % of the thermoplastic polymer; and 7-50 wt. % of the mineral additive, relative to a total weight of the resulting mixture.

Embodiment [66] of the present disclosure relates to the process of Embodiments [57]-[65], wherein the resulting mixture further comprises, as an additional polymer, a natural or synthetic polymer that is different from the thermoplastic polymer.

Embodiment [67] of the present disclosure relates to the process of Embodiments [57]-[66], wherein the resulting mixture further comprises an elastomer which is different from the thermoplastic polymer.

Embodiment [68] of the present disclosure relates to the process of Embodiments [57]-[67], wherein the mineral additive comprises at least one selected from the group consisting of an inorganic mineral, an allotrope of carbon, and an organic polymer.

Embodiment [69] of the present disclosure relates to the process of Embodiments [57]-[68], wherein the mineral additive comprises at least one selected from the group consisting of a silicate, an aluminosilicate, a diatomaceous earth, a perlite, a pumicite, a natural glass, a cellulose, an activated charcoal, a feldspar, a zeolite, a mica, a talc, a clay, a kaolin, a smectite, a wollastonite, a bentonite, and combinations thereof.

Embodiment [70] of the present disclosure relates to the process of Embodiments [57]-[69], wherein the mineral additive comprises a carbon black, an amorphous carbon, a graphite, a graphene, a carbon nanotube, a fullerene, or a mixture thereof.

Embodiment [71] of the present disclosure relates to the process of Embodiments [57]-[70], wherein the resulting mixture further comprises a filler material.

Embodiment [72] of the present disclosure relates to an object formed by the process of Embodiments [57]-[71].

### EXAMPLES

The following examples are provided for illustration purposes only and in no way limit the scope of the present disclosure. Embodiments of the present disclosure may employ the use of different or additional components compared to the materials illustrated below, such as other polymer formulations and objects based on different polymers and mineral additives, as well as additional components and different additives. Embodiments of the present disclosure may also employ the use of different process and manufacturing conditions than the conditions illustrated below for the preparation and use of polymer composites.

### Study Overview

In the examples illustrated below, various polymer formulations were prepared and used to create objects by additive manufacturing technologies. Different additives were included in the polymer formulations in order to study the effects of the additives on the physical properties of the resulting objects. Comparison studies below illustrate that the coalescence and adhesion of the individual layers formed during material extrusion (MEX) additive manufacturing is affected by the type of additive included in the polymer formulations. It is observed that the void space (or porosity) of the resulting objects depends on the nature of additives included in the polymer formulations, such that certain additives capable of reducing void space (or porosity) can improve coalescence and adhesion of the individual layers formed during additive manufacturing. It is also observed that the degree of physical (mechanical) anisotropy of the resulting objects is affected by the nature of the additives included in the polymer formulations, such that certain additives capable of reducing void space (or porosity) can improve the physical (mechanical) properties of the resulting objects by reducing anisotropy and warpage.

Materials

Commercial polypropylene (PP) random copolymer Dow DS6D21 (density=0.900 g/mL, melt index=8.0 g/10 minute at load of 2.16 kg and temperature of 230° C., melting point=811° C.) obtained from Dow Chemical Company was used as a PP polymer. Commercial PP random copolymer Vistamaxx™ 3588FL (density=0.889 g/mL, melt index=8.0 g/10 minute, Vicat softening temperature=103° C.) obtained from Exxon Mobil was used as a PP polymer. Commercial PP random copolymer YUPLENE® B360F (melt index=16.0 g/10 min (ASTM D1238), heat distortion temperature=90° C.) obtained from SK Global Chemical was used as a PP polymer. Commercial JetFil® 700C (talc mineral) (hydrated magnesium silicate) obtained from Imerys Talc was used as a mineral additive. Commercial Jetfine® 1H (talc mineral) obtained from Imerys Talc was used as a mineral additive. Commercial HAR® T84 (talc mineral) obtained from Imerys Talc was used as a mineral additive. Commercial NYLITE® 5 (Wollastonite mineral) obtained from Imerys was used as a mineral additive. Commercial ENGAGE™ 8200 (density=0.870 g/mL, melt index=5.0 g/10 min at load of 2.16 kg and temperature of 190° C., melting point=59.0° C.) obtained from Down Chemical Company was used a polymeric (elastomeric) additive. Commercial ENSACO® 250G (carbon black) obtained from Imerys was used as a polymeric (carbonaceous) additive. Commercial TIMREX® KS44 (graphite) obtained from Imerys was used a polymeric (carbonaceous) additive. A commercially available acrylonitrile butadiene styrene (ABS) filament obtained from Gizmo Dorks was used as a control ABS material, A commercially available polypropylene (PP) copolymeric filament obtained from Gizmo Dorks was used as a control PP material.

### Effect of Additives on Coalescence and Structural Uniformity of Objects Formed from Polypropylene-Based Composite Material Formulations

A number of polypropylene-based composite material formulations were prepared by processing a commercial PP copolymer with at least one additive, as summarized in Table 1 below. Reference Sample 1 was prepared by combining 60 wt. % of Dow DS6D2 (PP copolymer) with 30 wt. % of JetFil® 700C (talc mineral) and 10 wt. % of ENGAGE™ 8200 (polyolefin elastomer), and represents a typical polymer formulation used for injection molding. Sample 2 was prepared by combining 70 wt. % of Vistamaxx™ 3588 FL (PP copolymer) with 30 wt. % of HAR® T84 (talc mineral). Sample 3 was prepared by combining 70 wt. % of Vistamaxx™ 3588 FL (PP copolymer) with 30 wt. % of NYLITE® 5 (Wollastonite mineral). Sample 4 was prepared by combining 60 wt. % of Vistamaxx™ 3588 FL (PP copolymer) with 40 wt. % of TIMREX® KS44 (graphite). Sample 5 was prepared by combining 82 wt. % of Vistamaxx™ 3588 FL (PP copolymer) with 18 wt. % of ENSACO® 250G (carbon black).

TABLE 1
Polypropylene-Based Composite Materials

| Sample ID | 1 | 2 | 3 | 4 | 5 |
|---|---|---|---|---|---|
| Dow DS6D21 ^{a)} | 60 wt. % | — | — | — | — |
| Vistamaxx ™ 3588 | — | 70 wt. % | 70 wt. % | 60 wt. % | 82 wt. % |
| FL ^{a)} | | | | | |
| ENGAGE ™ 8200 ^{b)} | 10 wt. % | — | — | — | — |
| JetFil ® 700C ^{c)} | 30 wt. % | — | — | — | — |
| HAR ® T84 ^{c)} | — | 30 wt. % | — | — | — |
| NYLITE ® 5 ^{d)} | — | | 30 wt. % | — | — |
| TIMREX ® KS44 ^{e)} | — | — | — | 40 wt. % | — |
| ENSACO ® 250G ^{f)} | — | — | — | — | 18 wt. % |

^{a)} PP copolymer
^{b)} polyolefin elastomer
^{c)} talc mineral
^{d)} Wollastonite mineral
^{e)} graphite
^{f)} carbon black

The PP-based composite materials of Samples 1-5 were prepared by melt-mixing the PP copolymers with the additives shown in Table 1 above using a co-rotating twin-screw extruder HAAKE™ Rheomex PTW16. The extrusion temperature profile and screw speeds that were used are listed in Table 2 below.

Continuous filaments were then prepared from the extruded materials of Samples 1-5 using a single screw extruder and home-built water bath. The filaments of Samles 1-5 were then used as feedstock in a HYREL™ System 30 machine to fabricate a series of test towers by performing fused deposition modeling (FDM) 3D printing relying on material extrusion (MEX) technology to produce the “roads” used to form individual layers of the test towers. The test towers were shaped as a rectangular base measuring 30 mm×20 mm and a height of 2.5 mm. The printing conditions are summarized in Table 3 below.

TABLE 2
Extrusion Temperature Profile and Screw Rotating Speeds Used
in the Preparation of Samples 1-5

| Extrusion parameters | Value |
|---|---|
| T1 (° C.) | 150 |
| T2 (° C.) | 190 |
| T3 (° C.) | 190 |
| T4 (° C.) | 190 |
| T5 (° C.) | 190 |
| T6 (° C.) | 190 |
| T7 (° C.) | 190 |
| T8 (° C.) | 190 |
| T9 (° C.) | 190 |
| T10 (° C.) | 190 |
| Screw speed (rpm) | 450 |

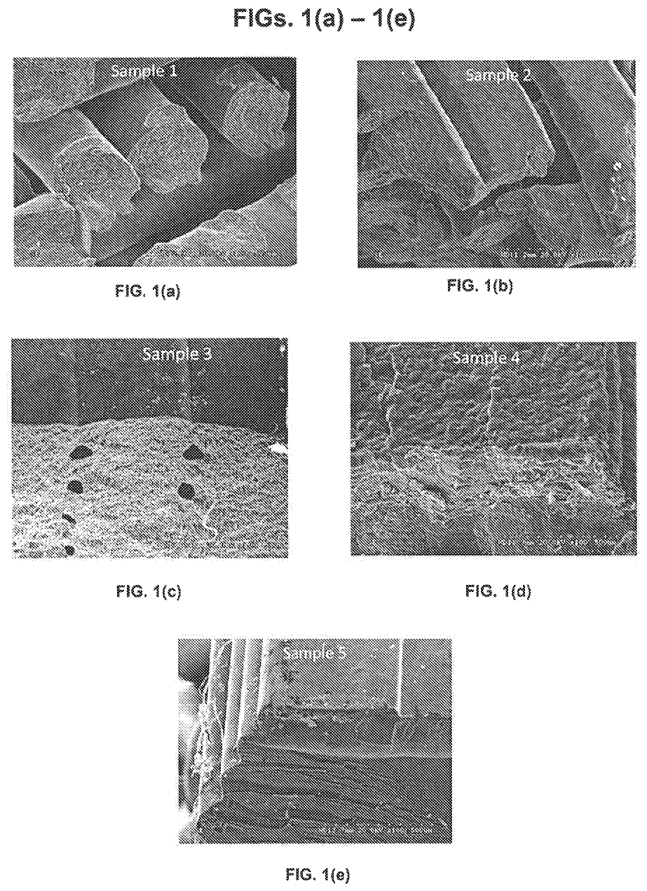

The internal structures of the test towers produced from Samples 1-5 were studied using a Hitachi S-4300SE/N® scanning electron microscope (SEM). Samples were cryogenically fractured with liquid nitrogen and then rendered conductive by a sputter deposition to produce a thin layer of gold. Representative images of the 5 test tower samples corresponding to Samples 1-5 are shown in FIGS. 1(a)-(e). Table 3 below shows the 3D printing conditions for the test towers of Samples 1-5.

TABLE 3
Printing Conditions for the Test Towers of Samples 1-5

| Printing parameters | Value |
|---|---|
| Temperature (° C.) | 210 |
| Fill Pattern | Rectilinear |
| Translation Speed | 20 |
| (mm/s) | |
| Fill Density (%) | 100% |

Table 4 below summarizes the compositional data for Samples 1-5, as well as the corresponding figures of SEM images of Samples 1-5 and void space data calculated from the radii of curvatures measured from the SEM images of the test towers.

The SEM images of FIGS. 1(a)-(e) reveal that blending a PP copolymer with the additives tested in Table 4 can achieve a significant improvement in coalescence of the layers deposited during a material extrusion-based 3D printing process. Comparing the images in FIGS. 1(a)-(e) shows that the coalescence of layers formed from the PP-based composite materials of Samples 1-5 depends greatly upon the nature of the additive.

TABLE 4
Summary of Data for Test Towers Produced from the
Polypropylene-Based Composite Materials of Samples 1-5

| Sample ID | 1 | 2 | 3 | 4 | 5 |
|---|---|---|---|---|---|
| Dow DS6D21 ^{a)} | 60 wt. % | — | — | — | — |
| Vistamaxx ™ 3588 | — | 70 wt. % | 70 wt. % | 60 wt. % | 82 wt. % |
| FL ^{a)} | | | | | |
| ENGAGE ™ 8200 ^{b)} | 10 wt. % | — | — | — | — |
| JetFil ® 700C ^{c)} | 30 wt. % | — | — | — | — |
| HAR ® T84 ^{c)} | — | 30 wt. % | — | — | — |
| NYLITE ® 5 ^{d)} | — | — | 30 wt. % | — | — |
| TIMREX ® KS44 ^{e)} | — | — | — | 40 wt. % | — |
| ENSACO ® 250G ^{h)} | — | — | — | — | 18 wt. % |
| SEM Image FIG. | 1(a) | 1(b) | 1(c) | 1(d) | 1(e) |
| Void Space ^{g)} | 21.5% | 8.2% | 4.6% | 0% | 0% |

^{a)} PP copolymer
^{b)} polyolefin elastomer
^{c)} talc mineral
^{d)} Wollastonite mineral
^{e)} graphite
^{f)} carbon black
^{g)} calculated from measured radii of curvature, as described below

The reference Sample 1 formed by adding a talc mineral additive (JetFil® 700C) and a polyolefin elastomer additive (ENGAGE™ 8200) to a PP copolymer (Dow DS6D21) resulted in the formation of a test tower in which the deposited “roads” were not effectively coalesced, see FIG. 1(a). The Sample 2 formed by adding a talc mineral additive (HAR® T84) to a PP copolymer (Vistamaxx™ 3588 FL) resulted in the formation of a test tower in which the coalescence of the deposited “roads” was slightly improved compared to the test tower of Sample 1, see FIG. 1(b). The Sample 3 formed by adding a Wollastonite mineral additive (NYLITE® 5) to a PP copolymer (Vistamaxx™ 3588 FL) resulted in the formation of a test tower in which the coalescence of the deposited “roads” was greatly improved compared to the test towers of Samples 1 and 2, see FIG. 1(c). Comparing the “void space” data for the test towers of Samples 1-3 in Table 4 also reveals that a dramatic reduction in the volume of the void space can occur depending upon the type of additive.

The Sample 4 formed by adding a carbon black additive (TIMREX® KS44) to a PP copolymer (Vistamaxx™ 3588 FL) resulted in the formation of a test tower in which the coalescence of the deposited “roads” was dramatically improved as compared to the test towers of Samples 1-3, see FIG. 1(d). No void space was detected in the test tower of Sample 4, as shown in Table 4 above.

The Sample 5 formed by adding a graphite additive (ENSACO® 250G) to a PP copolymer (Vistamaxx™ 3588 FL) resulted in the formation of a test tower in which the coalescence of the deposited “roads” was also dramatically improved compared to the test towers of Samples 1-3, see FIG. 1(e). No void space was detected in the test tower of Sample 5, as shown in Table 4 above. A qualitative comparison of the SEM images of FIGS. 1(d) and 1(e) appears to show that the test tower of Sample 5 was structurally superior to the test tower of Sample 4. As shown FIG. 1(d), the graphite particles appear to have agglomerated on the surface of the test tower of Sample 4. By contrast, as shown in FIG. 1(e), the deposited “roads” in the test tower of Sample 5 appear to be tightly coalesced and more homogeneous compared to the test tower of Sample 4.

Without being bound to any particular theory, it is believed that two factors may be responsible for the improved physical properties of the test towers corresponding to Samples 3-5. First, it is believed that polyolefins having a reduced amount of crystallinity (i.e., a low crystallization temperature, such as 70° C. at a cooling rate of 20° C./min.) may be ideal for performing additive manufacturing relying on material extrusion (MEX). Second, it is believed that formulating the low-crystallinity polyolefins with additives that reduce the specific heat, viscosity and/or density of the resulting composite material formulations, relative to the specific heat, viscosity and/or density of the polyolefins, improves the coalescence and adhesion of layers deposited during additive manufacturing.

The effect of specific heat on the properties of the test towers formed from the Samples 2-5 was analyzed by reference to the Table 5 below. As illustrated in Table 5, formulation with the mineral additive causes a reduction in the specific heat of the resulting composite materials, relative to the specific heat of the polypropylene. Furthermore, as illustrated by the SEM images of FIGS. 1(b)-(e), as the specific heat of the composite material is reduced the coalescence and structural uniformity of the resulting test towers is improved. It is also observed that as the specific heat of the composite material is further reduced (depending upon the nature of the additive) the void space of the resulting test towers is also reduced such that certain additives (e.g., carbon black and graphite) produce test towers with no measurable void space,

TABLE 5
Summary of Specific Heat Data for Samples 2-5

| Sample ID | 2 | 3 | 4 | 5 |
|---|---|---|---|---|
| Vistamaxx ™ 3588 | 70 wt. % | 70 wt. % | 60 wt. % | 82 wt. % |
| FL ^{a)} | | | | |
| ENGAGE ™ 8200 ^{b)} | — | — | — | — |
| JetFil ® 700C ^{c)} | — | — | — | — |
| HAR ® T84 ^{c)} | 30 wt. % | — | — | — |
| NYLITE ® 5 ^{d)} | — | 30 wt. % | — | — |
| TIMREX ® KS44 ^{e)} | — | — | 40 wt. % | — |
| ENSACO ® 250G ^{f)} | — | — | — | 18 wt. % |
| Specific Heat of PR | 1920 | 1920 | 1920 | 1920 |
| Copolymer (J/kg · K) | | | | |
| Specific Heat of | — | — | 1431 | 1683 |
| Composite Material | | | | |
| (J/kg · K) | | | | |
| SEM Image FIG. | 1(b) | 1(c) | 1(d) | 1(e) |
| Void Space ^{g)} | 8.2% | 4.6% | 0% | 0% |

^{a)} PP copolymer
^{b)} polyolefin elastomer
^{c)} talc mineral
^{d)} Wollastonite mineral
^{e)} graphite
^{f)} carbon black
^{g)} calculated from measured radii of curvature, as described below

Without being bound to any particular theory, it is believed that reducing the specific heat of a polyolefin-based composite material, relative to the specific heat of the polyolefin. may improve coalescence and adhesion during additive manufacturing thus enabling effective production of polyolefin-based objects using additive manufacturing relying on material extrusion (MEX).

In some embodiments combining a polyolefin with an additive having a lower specific heat than the polyolefin is observed to lower the specific heat of the resulting composite material formulation. For example, polypropylene has a specific heat of 1926 J/(kg⋅K) and wollastonite and graphite both have a specific heat of 712 J/(kg⋅K). Therefore, through the rule of mixtures, the addition of either a wollastonite or graphite to the polypropylene could reduce the specific heat of the resulting composite material—thereby reducing the amount of energy required to increase the temperature of the composite material. Assuming that the molten composite material does not fully achieve a homogeneous temperature in the liquefaction chamber, the reduced specific heat could improve liquefaction and decrease the density and viscosity to thereby improve coalescence of the molten “road” during 3D printing. In other embodiments it is believed that other properties of the additive are responsible for the improved coalescence and adhesion of bonded layers produced by additive manufacturing.

### Effect of Additives on Directional Properties of Objects Formed from Polypropylene-Based Composite Material Formulations

Anisotropy is the property of being dependent on directions. Therefore, by measuring the tensile property data of polypropylene-based test objects produced by 3D printing using different fill angles, the filament bonding performance can be tested to gauge the directional properties of the test objects. The studies outlined below demonstrate that the use of polypropylene-based composite materials of the present disclosure to produce test objects by 3D printing leads to a reduction of anisotropy.

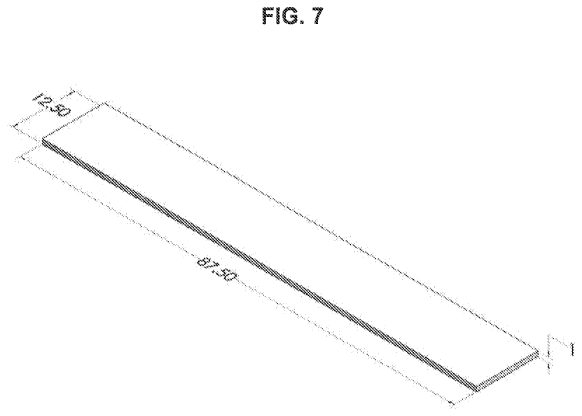

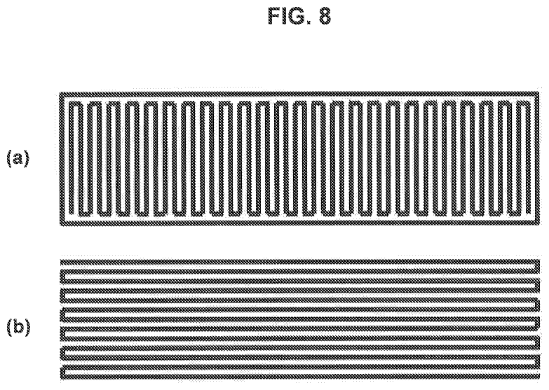

A series of thin flat strips having a constant rectangular cross section were fabricated by 3D printing using two fill angles, 0° and 90° , and were then tested using a method similar to ASTM D3039/D3039M-14. The 0° fill angle specimens were fabricated without perimeters, but the 90° fill angle specimens required three perimeters because the fabrication process was unsuccessful without them. The test specimen dimensions are shown in FIG. 7. FIGS. 8(a) and 8(b) are schematic representations showing the cross-sectional constructions of the test specimens produced using fill angles of 0° and 90°, respectively.

Five flat strip test specimens were produced using the polypropylene-based composite material of Sample 5 (see Table 1), which was prepared by combining 82 wt. % of Vistamaxx™ 3588 FL (PP copolymer) with 18 wt. % of ENSACO® 250G (carbon black). These flat strip test specimens were produced by performing material extrusion 3D printing at a deposition temperature of 280° C. The test specimens were tested using an lnstron 5566® Universal Testing Machine at a speed of 20 mm/min to produce failure within approximately 1 to 10 minutes. The physical properties of tensile stress at yield point, tensile stress at filament failure point, tensile nominal strain at failure point, and modulus of elasticity were measured, as are summarized in Table 6 below.

For purposes of the data summarized in Table 6 below, “yield point” was defined according to the testing standard as the first point on the stress-strain curve at which an increase in strain occurs without an increase in stress, The “filament failure point” was estimated to be the point where filaments began to fail during the test. Because the test specimens deformed differently over the entire length of the sample between the grips, a “nominal strain” was calculated and was used as the domain on the stress-strain curves. The “nominal strain” was calculated by dividing the crosshead extension by the distance between grips, which was 62.5 mm. It was observed that the test specimens with a 0° fill angle did not fail during the strength tests. Instead, the 0° fill angle specimens continued to extend until they were too thin for the Instron machine to grip.

TABLE 6
Summary of the Physical Properties of the Sample 5 Test Specimens

| Physical Property ^{h)} | 0° fill angle | 90° fill angle |
|---|---|---|
| Tensile stress at yield point (MPa) | 14.16 | 13.29 |
| Tensile stress at filament | 13.61 | 12.73 |
| failure point (MPa) | | |
| Tensile nominal strain at | 4.97 | 0.20 |
| failure point (mm/mm) | | |
| Modulus of Elasticity (MPa) | 375.49 | 351.38 |

^{h)} listed property values are the average of the 5 test specimens

As shown in the data summarized in Table 6, the tensile stresses at yield point and at filament failure point were very similar, and considered to be statistically equal. Therefore, it is concluded that a reduction in anisotropy was accomplished using the polypropylene-based composite material of Sample 5.

In addition, the typical value of tensile stress at yield point of an object formed from Vistamaxx™ 3588FL by injection molding is 15.8 MPa. Therefore, the tensile stress of the 3D printed object of Sample 5 is only slightly lower than that of an injection molded object using the same thermoplastic polymer. This observation was not expected, because most objects formed using additive manufacturing techniques exhibit tensile stress values of no greater than about 50% relative to corresponding tensile stress values of objects formed by injection molding techniques.

The one physical property in Table 6 that does show significant impact on the fill angle is the tensile nominal strain at filament failure point. Having a low value of tensile nominal strain at filament failure point indicates that the material in one direction is brittle. The average nominal strain of the test strips formed using a 0° fill angle was 4.97 mm/mm, compared to a value of 0.20 mm/mm for the average nominal strain of the test strips formed using a 90° fill angle—meaning that the distance of deflection at the point of failure is significantly lower in the 90° fill angle direction compared to the 0° fill angle direction. This phenomenon is typically observed in objects formed through additive manufacturing techniques, and can be advantageous in certain applications.

As shown in Table 6, the moduli of elasticity for the test strips formed using Sample 5 at 0° (375.49 MPa) and 90° (351.38 MPa) are similar, and the average modulus of elasticity for the test strips formed at a fill angle of 90° are only 7% lower than the average modulus of elasticity for the test strips formed at a fill angle of 0°. These results are surprisingly good for objects (especially polyolefin based objects) formed using additive manufacturing.

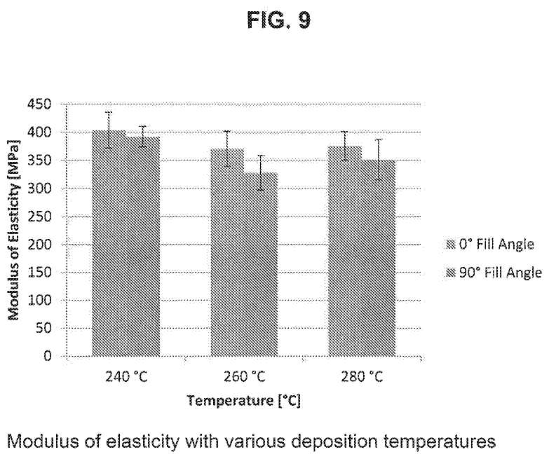

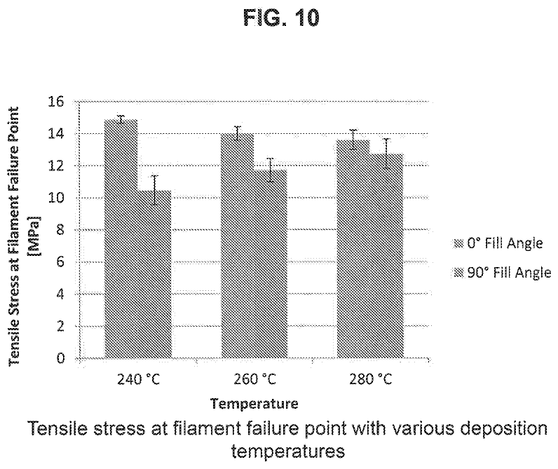

FIG. 9 shows how the modulii of elasticity of test strips formed using Sample 5 at fill angles of 0° and 90° vary as the temperature is increased from 240° C. to 280° C. FIG. 10 shows how the tensile stress at filament failure point of test strips formed using Sample 5 at fill angles of 0° and 90° vary as the temperature is increased from 240° C. to 280° C. This data shows that the difference in the tensile stress at filament failure point, for the test strips formed using Sample 5 at fill angles of 0° and 90°, appears to reduce in magnitude as the temperature is increased from 240° C. to 280° C. See FIG. 10. By contrast, the modulus of elasticity, for the test strips formed using Sample 5 at fill angles of 0′ and 90°, appears to be less affected as the temperature is increased from 240° C. to 280° C., See FIG. 9.

### Effect of Additives on Warpage and Porosity Properties of Objects Formed from Polypropylene-Based Composite Material Formulations

Additional studies were performed to measure the effect of the additives on the warpage and porosity of test towers formed by performing fused deposition modeling (FDM) 3D printing relying on material extrusion (MEX) technology. The data for these studies is summarized in Table 7 below.

As shown in Table 7, Samples 6-8 employed a commercial ABS filament (Gizmo Doriks) (Sample 6), a commercial polypropylene copolymer (Gizmo Works) (Sample 7) and a commercial random PP copolymer YUPLENE® B360F (Sample 8). Samples 9611 employed PP-based composite materials formed by combining YUPLENE® B360F with at least one additive. Sample 9 was prepared by combining 90 wt. % of YUPLENE® B360F (PP copolymer) with 10 wt. % of ENGAGE™ 8200 (polyolefin elastomer), and represents a typical polymer formulation used for injection molding. Sample 10 was prepared by combining 85 wt. % of YUPLENE® B360F (PP copolymer) with 15 wt. % of Jetfine® 1H (talc mineral). Sample 11 was prepared by combining 75 wt. % of YUPLENE® B360F (PP copolymer) with 15 wt. % of Jetfine® 1H (talc mineral) and 10 wt. % of ENGAGE™ 8200 (polyolefin elastomer).

TABLE 7
Commercial Polymers and Polypropylene-Based Composite
Materials Used in Warpage and Porosity Studies

| | Sample ID | | | | | |
|---|---|---|---|---|---|---|
| | 6 | 7 | 8 | 9 | 10 | 11 |
| ABS Filament ⁱ⁾ | 100 | — | — | — | — | — |
| | wt. % | | | | | |
| Commercial | — | 100 | — | — | — | — |
| PP ^{j)} | | wt. % | | | | |
| YUPLENE ® | — | — | 100 | 90 | 85 | 75 |
| B360F ^{k)} | | | wt. % | wt. % | wt. % | wt. % |
| ENGAGE ™ | — | — | — | 10 | — | 10 |
| 8200 ^{b)} | | | | wt. % | | wt. % |
| Jetfine ® 1H ^{l)} | — | — | — | — | 15 | 15 |
| | | | | | wt. % | wt. % |

^{b)} polyolefin elastomer
ⁱ⁾ commercial ABS filament (Gizmo Works)
^{j)} commercial PP copolymer (Gizmo Works)
^{k)} PP copolymer
^{l)} talc mineral

The commercial polymers and PP-based composite materials of Samples 6-11 were prepared by melt-mixing using a co-rotating twin-screw extruder HAAKE™ Rheomex PTW16, The extrusion temperature profile and screw speeds that were used are listed in Table 8 below.

Continuous 3 mm filaments were then prepared from the extruded materials of Samples 6-11 using a single screw extruder and home-built water bath. The filaments of Samles 6-11 were then used as feedstock in a HYREL™ System 30 machine to fabricate a series of test towers by performing fused deposition modeling (FDM) 3D printing relying on material extrusion (MEX) technology to produce the “roads” used to form individual layers of the test towers. The test towers were shaped as a rectangular base measuring 30 mm×20 mm and a height of 2.5 mm. The printing conditions are summarized in Table 9 below.

TABLE 8
Extrusion Temperature Profile and Screw Rotating Speeds Used
in the Preparation of Samples 6-11

| Extrusion parameters | Value |
|---|---|
| T1 (° C.) | 150 |
| T2 (° C.) | 190 |
| T3 (° C.) | 190 |
| T4 (° C.) | 190 |
| T5 (° C.) | 190 |
| T6 (° C.) | 190 |
| T7 (° C.) | 190 |
| T8 (° C.) | 190 |
| T9 (° C.) | 190 |
| T10 (° C.) | 190 |
| Screw speed (rpm) | 450 |

TABLE 9
3D Printing Conditions for the Test Towers of Samples 6-11

| Printing parameters | Value |
|---|---|
| Temperature (° C.) | 170 |
| Fill Pattern | Rectilinear |
| Translation Speed | 30 |
| (mm/s) | |
| Fill Density (%) | 100% |

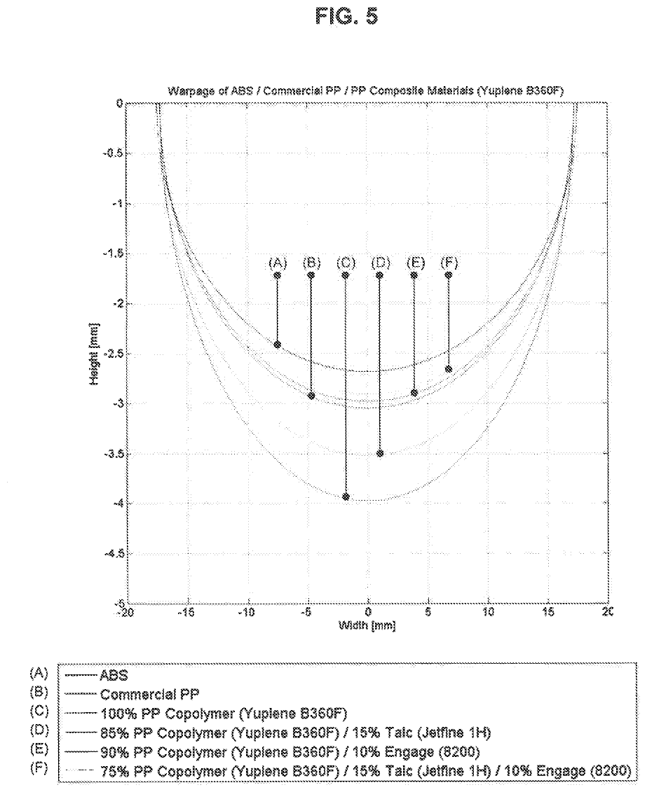

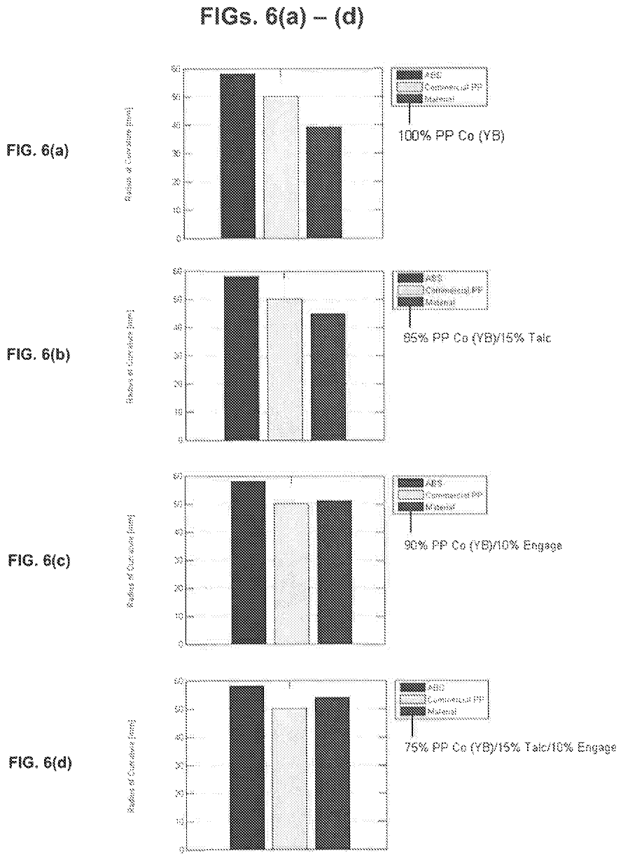

The dimensional accuracy of the test towers formed from Samples 6-11 was measured using the radius of curvature method detailed below. Warpage plots for the test towers from Samples 6-11 were also obtained by measuring the warpage at the corners of the test towers. The experimental data is summarized in Table 10 below by reference to FIGS. 5 and 6(a)-(d).

As summarized in Table 10 below, the radii of curvature for the commercial polymers of Samples 6-8 decreases from a radius of curvature of 58.0 mm for the ABS polymer of Sample 6 to a radius of curvature of 50.0 mm for the Commercial PP of Sample 7 to the radius of curvature of only 39.8 mm for the YUPLENE® B360F of Sample 8. This trend illustrates why certain commercially-useful polyolefins, such as YUPLENE® B360F, are not well suited for use as materials in 3D printing applications. This data is visually summarized in FIGS. 6(a)-(d).

TABLE 10
Summary of Data for Test Towers Produced from Commercial
Polymers and Polypropylene-Based Composite Materials

| | Sample ID | | | | | |
|---|---|---|---|---|---|---|
| | 6 | 7 | 8 | 9 | 10 | 11 |
| ABS Filament ⁱ⁾ | 100 | — | — | — | — | — |
| | wt. % | | | | | |
| Commercial PP ^{j)} | — | 100 | — | — | — | — |
| | | wt. % | | | | |
| YUPLENE ® | — | — | 100 | 90 | 85 | 75 |
| B360F ^{k)} | | | wt. % | wt. % | wt. % | wt. % |
| ENGAGE ™ | — | — | — | 10 | — | 10 |
| 8200 ^{b)} | | | | wt. % | | wt. % |
| Jet-fine ® 1H ^{l)} | — | — | — | — | 15 | 15 |
| | | | | | wt. % | wt. % |
| FIG. 5 Warpage | (A) | (B) | (C) | (E) | (D) | (F) |
| Plot Label | | | | | | |
| Radius of Curvature | 6(a)-(d) | 6(a)-(d) | 6(a) | 6(c) | 6(b) | 6(d) |
| FIG. # | | | | | | |
| Radius of | 58.0 | 50.0 | 39.8 | 51.0 | 44.5 | 55.0 |
| Curvature (mm) | | | | | | |

^{b)} polyolefin elastomer
ⁱ⁾ commercial ABS filament (Gizmo Dorks)
^{j)} commercial PP copolymer (Gizmo Dorks)
^{k)} PP copolymer
^{l)} talc mineral

As shown in FIG. 5, the warpage measurements for Samples 6-8 show a clear trend between the radii of curvature (porosity) and the degree of warpage. The test tower of Sample 6 (ABS) having a radius of curvature of 58.0 mm exhibited the lowest amount of warpage (A), as illustrated in FIG. 5. The test tower of Sample 7 (Commercial PP) having a radius of curvature of 50.0 mm exhibited a significant increase in the amount of warpage (B), as compared to the test tower of Sample 6 (A). The test tower of Sample 8 (YUPLENE® B360F) having the lowest radius of curvature of only 39.8 mm exhibited the highest amount of warpage (C), compared to ail of the test towers of Samples 6-11.

The data in Table 10 an FIG. 5 also demonstrates that the addition of certain additives to the YUPLENE® B360F can both increase the radius of curvature (reduce porosity) and reduce the amount of warpage in the corresponding test towers.

The test tower of Sample 9 (90 wt. % of YUPLENE® B360F+10 wt. % of ENGAGE™ 8200) exhibited an increased radius of curvature to 51.0 mm (less porous), compared to the test tower of Sample 8 (100 wt. % of YUPLENE® B360F). The warpage data in FIG. 5 also shows that the amount of warpage for the test tower of Sample 9 (E) was significantly less, compared to the amount of warpage for the test tower of Sample 8 (C). The test tower of Sample 10 (85 wt. % of YUPLENE® B360F +15 wt. % of Jetfine® 1H) exhibited an increased radius of curvature to 44.5 mm (less porous), compared to the test tower of Sample 8 (100 wt. % of YUPLENE® B360F). The warpage data in FIG. 5 also shows that the amount of warpage for the test tower of Sample 10 (D) was significantly less, compared to the amount of warpage for the test tower of Sample 8 (C). The test tower of Sample 11 (75 wt. % of YUPLENE® B360F+15 wt. % of Jetfine® 1H+10 wt. % of ENGAGE™ 8200) exhibited an increased radius of curvature to 55.0 mm (less porous), compared to the test tower of Sample 8 (100 wt. % of YUPLENE® B360F). The warpage data in FIG. 5 also shows that the amount of warpage for the test tower of Sample 11 (F) was significantly less, compared to the amount of warpage for the test tower of Sample 8 (C).

Comparing the experimental results of for the test towers produced from the additive-containing materials of Samples 9-11 shows that certain additives can greatly improve the properties of objects formed by 3D printing of polyolefin-containing filaments. Higher dimensional accuracy was achieved through addition of a talc mineral (Jetfine® 1H) and a polyolefin elastomer (ENGAGE™ 8200) to a polypropylene copolymer (YUPLENE® B360F), see Sample 11 in Table 10 and plot (F) in FIG. 5.

### Measurement of Radius of Curvature and Void Space

The radii of curvature in Table 10 and in FIGS. 6(a)-(d) were measured by the following procedure. (1) The lengths and widths of the test towers were measured, and average values were calculated. (2) The theoretical diagonal lengths of the test towers were then calculated using the Pythagorean Theorem. (3) The actual diagonal lengths of the test towers were physically measured to obtain average values. (4) Assuming that the printed part represents half of an ellipse, semi-minor axes b were calculated based on the geometric representation below:

(5) The perimeters of ellipses of the test towers are approximated using the following relationship:

$$perimeter \approx π ( a + b ) ( 1 + \frac{3 h}{10 + \sqrt{4 - 3 h}} )$$

where:

$$h = \frac{{( a - b )}^{2}}{{( a + b )}^{2}}$$

(6) The radii of curvature of the test towers are then calculated using the following relationship based on the geometric representation below:

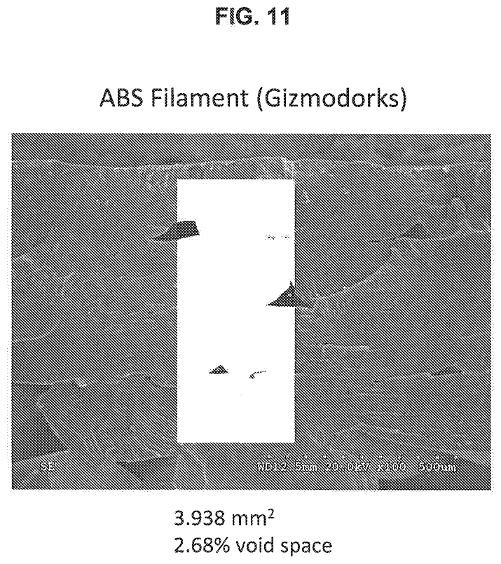

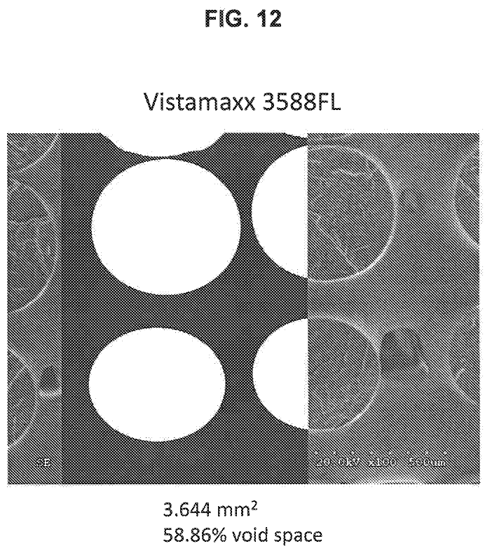

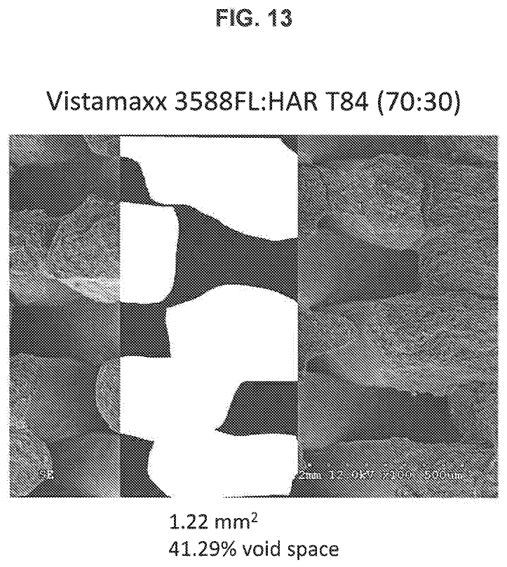

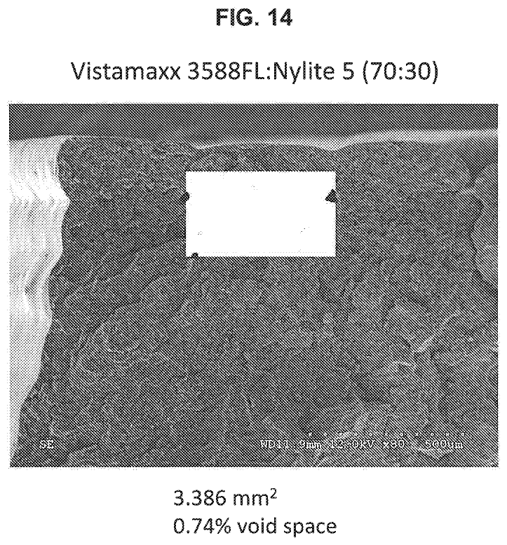

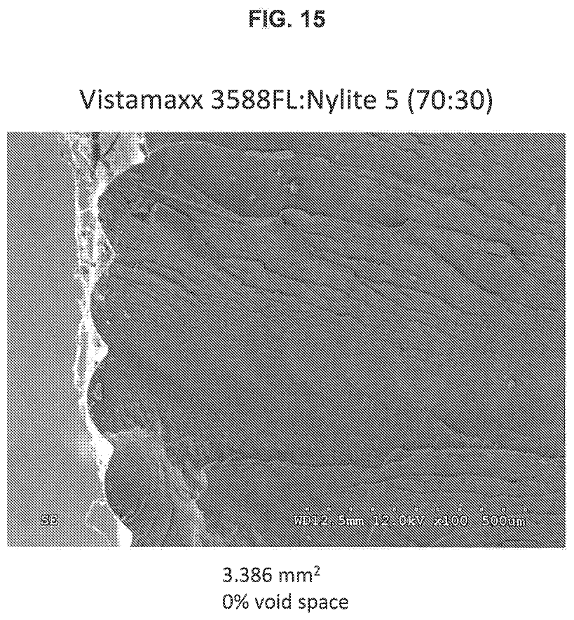

Void space may be calculated from the radius of curvature, or may be determined by measuring the void space visible in high-contrast SEM images. FIGS. 11-15 illustrate high-contrast SEM images used to measure the void spaces of the Samples 12-16 shown in Table 11 below.

TABLE 11
Summary of Specific Heat Data for Samples 2-5

| Sample ID | 12 | 13 | 14 | 15 | 16 |
|---|---|---|---|---|---|
| ABS Filament ⁱ⁾ | 100 wt. % | — | — | — | — |
| Vistamaxx ™ | — | 100 wt. % | 70 wt. % | 70 wt. % | 70 wt. % |
| 3588 FL ^{a)} | | | | | |
| HAR ® T84 ^{c)} | — | — | 30 wt. % | — | — |
| NYLITE ® 5 ^{d)} | — | — | — | 30 wt. % | 30 wt. % |
| SEM image FIG. | 11 | 12 | 13 | 14 | 15 |
| Void Space ^{m)} | 2.68% | 58.86% | 41.29% | 0.74% | 0% |

^{a)} PP copolymer
^{c)} talc mineral
^{d)} Wollastonite mineral
ⁱ⁾ commercial ABS filament (Gizmo Works)
^{m)} measured from high-contrast SEM image, as described above

As illustrated in the Samples 1416 in Table 11 above, compositions containing a commercial polypropylene copolymer (Vistamaxx™ 3588 FL) mixed with mineral additives (HAR® T84 and NYLITE® 5), when subjected to an additive manufacturing process, produce test samples exhibiting significantly lower void spaces relative to the void space of the polypropylene copolymer by itself (Sample 13). Samples 15 and 16, which both employed a mixture of 70 wt. % Vistamaxx (polypropylene copolymer) and 30 wt. % Nylite (wallastonite), produced test samples having almost no void space.

The above description is presented to enable a person skilled in the art to make and use the invention, and is provided in the context of a particular application and its requirements. Various modifications to the embodiments disclosed herein will be readily apparent to those skilled in the art, and the generic principles defined herein may be applied to other embodiments and applications without departing from the spirit and scope of the invention, Thus, this invention is not intended to be limited to the embodiments shown, but is to be accorded the widest scope consistent with the principles and features disclosed herein. In this regard, certain embodiments within the disclosure may not show every benefit of the invention, considered broadly.

1. A composition for additive manufacturing, the composition comprising:
a thermoplastic polymer; and
a mineral additive capable of reducing a specific heat of the composition relative to a specific heat of the thermoplastic polymer,
wherein:
a proportion of the mineral additive in the composition is set such that the specific heat of the composition is equal to or less than 95% of the specific heat of the thermoplastic polymer;
the composition is in the form of a filament, rod, pellet or granule; and
the composition is adapted to function as a composition suitable for performing additive manufacturing by material extrusion.

2. The composition of claim 1, wherein the thermoplastic polymer comprises a polyolefin.

3. The composition of claim 1, wherein the thermoplastic polymer comprises a random or block co-polyolefin.

4. The composition of claim 1, wherein the thermoplastic polymer comprises a random or block co-polypropylene.

5. The composition of claim 1, further comprising, as an additional polymer, a natural or synthetic polymer that is different from the thermoplastic polymer.

6. The composition of claim 1, further comprises at least one additional polymer selected from the group consisting of a polyamide, a polycarbonate, a polyimide, a polyurethane, a polyalkylenemine, a polyoxyalkylene, a polyester, a polyacrylate, a polylactic acid, a polysiloxane, a polyolefin and copolymers and blends thereof.

7. The composition of claim 1, further comprising an elastomer that is different from the thermoplastic polymer.

8. The composition of claim 1, wherein the thermoplastic polymer has a density of equal to or less than 0.9 g/cm3.

9. The composition of claim 1, wherein the thermoplastic polymer is a crystalline, semi-crystalline or amorphous polymer.

10. The composition of claim 1, wherein the thermoplastic polymer has a crystallization temperature of equal to or less than 70° C. at a cooling rate of 20° C. per minute.

11. The composition of claim 1, wherein the mineral additive comprises at least one selected from the group consisting of an inorganic mineral, an allotrope of carbon, and an organic polymer.

12. The composition of claim 1, wherein the mineral additive comprises at least one selected from the group consisting of a silicate, an aluminosilicate, a diatomaceous earth, a perlite, a pumicite, a natural glass, a cellulose, an activated charcoal, a feldspar, a zeolite, a mica, a talc, a clay, a kaolin, a smectite, a wollastonite, a bentonite, and combinations thereof.

13. The composition of claim 1, wherein the mineral additive comprises at least one inorganic mineral selected from the group consisting of phenakite (Be₂SiO₄), willemite (Zn₂SiO₄), forsterite (Mg₂SiO₄), fayalite (Fe₂SiO₄), tephroite (Mn₂SiO₄), pyrope (Mg₃Al₂(SiO₄)₃), almandine (Fe₃Al₂(SiO₄)₃), spessartine (Mn₃Al₂(SiO₄)₃), grossular (Ca₃Al₂(SiO₄)₃), andradite (Ca₃Fe₂(SiO₄)₃), uvarovite (Ca₃Cr₂(SiO₄)₃), hydrogrossular (Ca₃Al₂Si₂O₈(SiO₄)₃₋ₘ(OH)₄ₘ), zircon (ZrSiO₄), thorite ((Th,U)SiO₄), perlite (Al₂SiO₅), andalusite (Al₂SiO₅), kyanite (Al₂SiO₅), sillimanite (Al₂SiO₅), dumortierite (Al_{6.5-7}BO₃(SiO₄)₃(O,OH)₃), topaz (Al₂SiO₄(F,OH)₂), staurolite (Fe₂Al₉(SiO₄)₄(O,OH)₂), humite ((Mg,Fe)₇(SiO₄)₃(F,OH)₂), norbergite (Mg₃(SiO₄)(F,OH)₂), chondrodite (Mg₅(SiO₄)₂(F,OH)₂), humite (Mg₇(SiO₄)₃ (F,OH)₂), clinohumite (Mg₉(SiO₄)₄(F,OH)₂), datolite (CaBSiO₄(OH)), titanite (CaTiSiO₅), chloritoid ((Fe,Mg,Mn)₂Al₄Si₂O₁₀(OH)₄), mullite (aka Porcelainite)(Al₆Si₂O₁₃), hemimorphite (calamine) (Zn₄(Si₂O₇)(OH)₂⋅H₂O), lawsonite (CaAl₂(Si₂O₇)(OH)₂⋅H₂O), ilvaite (CaFe^{II}₂Fe^{III}O(Si₂O₇)(OH)), epidote (Ca₂(Al,Fe)₃₀(SiO₄)(Si₂O₇)(OH)), zoisite (Ca₂Al₃₀ (SiO₄)(Si₂O₇)(OH)), clinozoisite (Ca₂Al₃₀(SiO₄)(Si₂O₇)(OH)), tanzanite (Ca₂Al₃₀(SiO₄) (Si₂O₇)(OH)), allanite (Ca(Ce,LaY,Ca)Al₂(Fe^{II},Fe^{III})O(SiO₄)(Si₂O₇)(OH)), dollaseite (Ce)(CaCeMg₂Al Si₃O₁₁F(OH)), vesuvianite (idocrase) (Ca₁₀(Mg,Fe)₂Al₄(SiO₄)₅ (Si₂O₇)₂(OH)₄), benitoite (BaTi(Si₃O₉), axinite ((Ca, Fe,Mn)₃Al₂(BO₃)(Si₄O₁₂)(OH), beryl/emerald (Be₃Al₂(Si₆O₁₈), sugilite (KNa₂(Fe,Mn,Al)₂Li₃Si₁₂O₃₀), cordierite ((Mg, Fe)₂ Al₃(Si₅AlO₁₈), tourmaline ((Na,Ca)(Al,LiNg)₃-(Al,Fe,Mn)₆ (Si₆O₁₈(BO₃)₃ (OH)₄), enstatite (MgSiO₃), ferrosilite (FeSiO₃), pigeonite (Ca_{0.25}(Mg,Fe)_{1.75}Si₂O₆), diopside (CaMgSi₂O₆), hedenbergite (CaFeSi₂O₆), augite ((Ca, Na)(Mg, Fe,Al) (Si,Al)₂O₆), jadeite (NaAlSi₂O₆), aegirine(acmite) (NaFe^{III}Si₂O₆), spodumene (LiAlSi₂O₆), wollastonite (CaSiO₃), rhodonite (MnSiO₃), pectolite (NaCa₂(Si₃O₈)(OH)), anthophyllite ((Mg, Fe)₇Si₈O₂₂(OH)₂), cummingtonite (Fe₂Mg₅Si₈O₂₂(OH)₂), grunerite (Fe₇Si₈O₂₂(OH)₂), tremolite (Ca₂Mg₅Si₈O₂₂(OH)₂), actinolite (Ca₂(Mg,Fe)₅Si₈O₂₂(OH)₂), hornblende ((Ca, Na)₂₋₃(Mg, Fe,Al)₅Si₆ (Al, Si)₂O₂₂ (OH)₂), glaucophane (Na₂Mg₃Al₂ Si₈O₂₂(OH)₂), riebeckite (asbestos) (Na₂Fe^{II}₃ Fe^{III}₂Si₈O₂₂(OH)₂), arfvedsonite (Na₃ (Fe, Mg)₄FeSi₈O₂₂(OH)₂), antigorite (Mg₃Si₂O₅(OH)₄), chrysotile (Mg₃Si₂O₅(OH)₄), lizardite (Mg₃Si₂O₅(OH)₄), halloysite (Al₂Si₂O₅(OH)₄), kaolinite (Al₂Si₂O₅(OH)₄), illite ((K,H₃O)(Al,Mg,Fe)₂ (Si,Al)₄ O₁₀[(OH)₂,(H₂O)]), montmorillonite ((Na,Ca)_{0.33} (Al,Mg)₂ Si₄O₁₀(OH)₂⋅nH₂O), vermiculite ((MgFe,Al)₃(Al,Si)₄O₁₀(OH)₂⋅4H₂O), talc (Mg₃Si₄O₁₀ (OH)₂), sepiolite (Mg₄Si₆O₁₆(OH)₂⋅6H₂O), palygorskite (or attapulgite) ((Mg,Al)₂Si₄O₁₀ (OH)⋅₄(H₂O)), pyrophyllite (Al₂Si₄O₁₀(OH)₂), biotite (K(Mg,Fe)₃(AlSi₃)O₁₀(OH)₂), muscovite (KAl₂(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), margarite (CaAl₂(Al₂Si₂)O₁₀(OH)₂), glauconite ((K,Na) (Al,Mg,Fe)₂(Si,Al)₄O₁₀(OH)₂), chlorite ((Mg, Fe)₃(Si,Al)₄O₁₀(OH)₂⋅(Mg, Fe)₃(OH)₆), quartz (SiO₂), tridymite (SiO₂), cristobalite (SiO₂), coesite (SiO₂), stishovite (SiO₂), microcline (KAlSi₃O₈), orthoclase (KAlSi₃O₈), anorthoclase ((Na,K)AlSi₃O₈), sanidine (KAlSi₃O₈), albite (NaAlSi₃O₈), oligoclase ((Na,Ca)(Si,Al)₄O₈(Na:Ca 4:1)), andesine ((Na,Ca)(Si,Al)₄O₈(Na:Ca 3:2)), labradorite ((Ca, Na)(Si,Al)₄O₈(Na:Ca 2:3)), bytownite ((Ca, Na)(Si,Al)₄O₈(Na:Ca 1:4)), anorthite (CaAl₂Si₂O₈), nosean (Na₈Al₆Si₆O₂₄(SO₄)), cancrinite (Na₆Ca₂(CO₃,Al₆Si₆O₂₄)⋅2H₂O), leucite (KAlSi₂O₆), nepheline ((Na, K) AlSiO₄), sodalite (Na₈(AlSiO₄)₆Cl₂), hauyne ((Na,Ca)₄₋₈Al₆Si₆(O,S)24(SO₄,Cl)₁₋₂), lazurite ((Na,Ca)₈(AlSiO₄)₆(SO₄,S,Cl)₂), petalite (LiAlSi₄O₁₀), marialite (Na₄ (AlSi₃O₈)₃(Cl₂,CO₃,SO₄)), meionite (Ca₄(Al₂Si₂O₈)₃ (Cl₂CO₃,SO₄)), analcime (NaAlSi₂O₆⋅H₂O), natrolite (Na₂Al₂Si₃ O₁₀⋅2H₂O), erionite ((Na₂,K₂,Ca)₂ Al₄Si₁₄O₃₆⋅15H₂O), chabazite (CaAl₂Si₄O₁₂⋅6H₂O), heulandite (CaAl₂Si₇O₁₈⋅6H₂O), stilbite (NaCa₂Al₅Si₁₃O₃₆⋅17H₂O), scolecite (CaAl₂Si₃O₁₀⋅3H₂O), and mordenite ((Ca, Na₂,K₂)Al₂Si₁₀O₂₄⋅7H₂O).

14. The composition of claim 1, wherein the mineral additive comprises a carbon black, an amorphous carbon, a graphite, a graphene, a carbon nanotube, a fullerene, or a mixture thereof.

15. The composition of claim 1, further comprising a filler material.

16. The composition of claim 1, further comprising at least one filler material selected from the group consisting of a silica, an alumina, a wood flour, a gypsum, a talc, a mica, a carbon black, a montmorillonite mineral, a chalk, a diatomaceous earth, a sand, a gravel, a crushed rock, bauxite, limestone, sandstone, an aerogel, a xerogel, a microsphere, a porous ceramic sphere, a gypsum dihydrate, calcium aluminate, magnesium carbonate, a ceramic material, a pozzolamic material, a zirconium compound, a crystalline calcium silicate gel, a perlite, a vermiculite, a cement particle, a pumice, a kaolin, a titanium dioxide, an iron oxide, calcium phosphate, barium sulfate, sodium carbonate, magnesium sulfate, aluminum sulfate, magnesium carbonate, barium carbonate, calcium oxide, magnesium oxide, aluminum hydroxide, calcium sulfate, barium sulfate, lithium fluoride, a polymer particle, a powdered metal, a pulp powder, a cellulose, a starch, a lignin powder, a chitin, a chitosan, a keratin, a gluten, a nut shell flour, a wood flour, a corn cob flour, calcium carbonate, calcium hydroxide, a glass bead, a hollow glass bead, a seagel, a cork, a seed, a gelatin, a wood flour, a saw dust, an agar-based material, a glass fiber, a natural fibers, and mixtures thereof.

17. The composition of claim 1, wherein:
the specific heat of the thermoplastic polymer is equal to or greater than 1900 J/kg⋅K; and
the specific heat of the composition is equal to or less than 1800 J/kg⋅K.

18. The composition of claim 1, wherein the proportion of the mineral additive in the composition is set such that the specific heat of the composition is equal to or less than 90% of the specific heat of the thermoplastic polymer.

19. The composition of claim 1, wherein the proportion of the mineral additive in the composition ranges from 1 percent by weight to 80 percent by weight, relative to a combined weight of the thermoplastic polymer and the mineral additive.

20. The composition of claim 1, comprising:
50-93 wt. % of the thermoplastic polymer; and
7-50 wt. % of the mineral additive, relative to a total weight of the composition.

21-72. (canceled)
